(19) United States
(12) Patent Application Publication
(10) Pub. No.: US 2009/0019826 A1
(43) Pub. Date: Jan. 22, 2009

(54) METHOD AND APPARATUS FOR PROCESSING PLANT MATERIALS FOR BIO-FUEL PRODUCTION

(76) Inventor: James Edward Rigney, Singhampton (CA)

Correspondence Address: STUART WILKINSON, 833 CALDER ROAD, MISSISSAUGA, ON, L5J 2N6, CA

(21) Appl. No.: 12/168,060

(22) Filed: Jul. 3, 2008

Related U.S. Application Data
(60) Provisional application No. 60/947,656, filed on Jul. 3, 2007.
(60) Provisional application No. 60/952,449, filed on Jul. 27, 2007.
(60) Provisional application No. 60/974,499, filed on Sep. 24, 2007.

(51) Int. Cl. A01D 45/00; A01D 45/02; A01D 41/00

(52) U.S. Cl. 56/13.5; 56/53

(57) ABSTRACT

A processor for processing standing plants has a primary crop sub-system for processing upper parts of the standing plants and a secondary crop sub-system for processing lower parts of the standing plants, the primary and secondary crop sub-systems operable to process the respective upper and lower parts of the standing plants as the processor moves through a stand of the standing plants. The processor, as part of a field located vehicle, is operated to separate a primary crop such as corn cobs or grain from the standing plant at a first processor zone, and to separate a secondary crop suitable for bio-fuel processing from the standing plant at a second processor zone. Settings of the primary and secondary crop sub-systems can be made adjustable so that the relative lengths of upper, lower and root parts of the standing plants can be adjusted as desired.

### CROSS REFERENCE TO RELATED PATENTS

The present application claims priority under 35 U.S.5 C. §119(e) from the provisional U.S. patent application Ser. No. 60/947,656 filed on Jul. 3, 2007, entitled, “Harvesting and Preparing Plant Material for Bio-fuel Production” the contents of which are incorporated herein by reference thereto.

The present application claims priority under 35 U.S.5 C. §119(e) from the provisional U.S. patent application Ser. No. 60/952,449 filed on Jul. 27, 2007, entitled, “Harvesting and Preparing Plant Material for Bio-fuel Production” the contents of which are incorporated herein by reference thereto.

The present application claims priority under 35 U.S.5 C. §119(e) from the provisional U.S. patent application Ser. No. 60/974,499 filed on Sep. 24, 2007, entitled, “Harvesting and Preparing Plant Materials for Bio-fuel Production” the contents of which are incorporated herein by reference thereto.

### TECHNICAL FIELD OF THE INVENTION

This invention relates to a method and apparatus for processing plant materials in preparation for chemical processing to bio-fuels and has particular application to processing standing plants.

### DESCRIPTION OF RELATED ART

In known methods for harvesting and preparing plant material for biofuel production, standing plant material such as switch grass is cut, collected, baled and taken to a processing facility. There, typically, the bales are ejected into a tub grinder in which a hammer mill crushes, grinds, chips, and shreds the bale contents. This part of the process produces fragments of plant material which are then subjected to chemical processing.

It would be of value to have at least some part of the processing of plant materials for bio-fuels performed other than at a central processing facility.

### SUMMARY OF THE INVENTION

According to one aspect of the invention, there is provided a processor for processing standing plants, the processor comprising a primary crop sub-system for processing upper parts of standing plants and a secondary crop sub-system for processing lower parts of the standing plants, the primary and secondary crop sub-systems operable to process the respective upper and lower parts of the standing plants as the harvester moves through a stand of the standing plants.

Preferably, the primary crop sub-system has a first separator for separating the upper part of each of the standing plants from the lower part of each of the standing plants. The primary crop sub-system can further include a second separator for separating a primary crop portion of the upper part from a residue portion of the upper part and a feed mechanism to collect the residue portion and to direct the residue portion to the secondary crop sub-system.

Particularly for corn plants, the primary crop sub-system can have a first mechanism to break corn ears from the standing plant and a second mechanism to remove husk material from the corn ears. Similarly, for a grain bearing plant, the first separator can comprise a first cutter for cutting the upper parts of the standing plants away from the lower parts of the standing plants, and a mechanism for processing the upper parts to separate grain content of the upper parts from chaff content of the upper parts.

In use, a decision is made as to what part of the standing plant is to be processed to furnish a primary crop, what part of the standing plant is to be processed to furnish bio-materials for subsequent conversion to bio-fuel, and what part of the plant is to be left as a root portion to be subsequently returned to the ground to nourish it. Preferably, the processor includes adjustment means to alter the positions of the first and second cutters to alter the lengths of the upper part, the lower part and the root part into which each of the standing plants is separated.

The secondary crop sub-system can further include a feeder operable to receive the cut lower parts from the second cutter, to orientate the cut lower parts into general alignment, and to pass the cut lower parts to a chopping head operable to effect a chopping action on the cut lower parts passed to the chopping head. Elements of the chopping head can be located and dimensioned to also introduce a measure of grinding of the cut lower parts. The length and condition of fragments into which the cut lower parts are chopped and, optionally ground, is selected in dependence on the nature of the particular standing plant and the subsequent chemical processing steps to which the fragments are to be subjected. The chopping head can include rotatable disc blades or flail knives hinged to rotatable shafts. Elements of the chopping head can be dimensioned and located to chop the plant material into fragments in the range of one quarter inch to one inch, the secondary crop sub-system then further including a director means to direct the fragments to a collector. Alternatively, elements of the chopping head can be dimensioned and located to chop the plant material into lengths of the order of several inches to one foot, the secondary crop sub-system then further including a director means operable as the processor moves through a stand of the standing plants, to eject the lengths from the processor as a swath. Plant material in the swath is then harvested at a later time after undergoing air drying.

Within a vehicular harvester/processor adapted to be driven through a field of standing plants, the primary crop sub-system and the secondary crop sub-system can occupy first and second zones respectively of the vehicular harvester/processor, the first zone typically located above and forwardly of the second zone in a drive direction of the vehicular harvester/processor.

According to another aspect of the invention, a method of processing standing plants comprises moving a processor having a primary crop sub-system and a secondary crop sub-system through a stand of the standing plants, operating the primary crop sub-system to separate an upper part of each of the standing plants from a lower part of the standing plant and to process the upper part, and operating the secondary crop sub-system to cut a lower part of the standing plant from a root part of the standing plant and to process the lower part.

Particularly for standing plants that are corn plants, operating the primary crop sub-system to separate an upper part of each of the standing plants from a lower part of the standing plant and processing the upper part can comprise breaking a corn ear from the standing plant, removing husk material from the corn ear and directing the removed husk material to the secondary crop sub-system. For standing plants that are grain bearing plants, operating the primary crop sub-system to separate an upper part of each of the standing plants from a lower part of the standing plant and processing the upper part can comprise cutting an upper part of each of the standing plants from a lower part of the standing plant, and separating a grain portion of the upper part from a chaff portion thereof.

Depending on desired relative lengths of upper parts, lower parts and root parts of the standing plant, the method of processing standing plants further comprises altering a height setting of the primary crop sub-system and altering a height setting of the secondary crop sub-system. Preferably the method further comprises receiving the cut lower parts, orientating the cut lower parts into general alignment, and passing the cut lower parts to a chopping head and chopping the cut lower parts.

The cut lower parts are preferably chopped into fragments generally in the range of one quarter of an inch to one inch, the method further comprising directing the fragments to a collector. Alternatively, the method of processing further comprises chopping the cut lower parts into lengths generally in the range of several inches to one foot and directing the chopped lengths to a field-based swath.

The processor can be implemented within a vehicle having features well known within the combine harvesting art such as an in-board drive which operates to drive the vehicle forward and take-off drives which are used to operate the primary and secondary crop sub-systems. Alternatively, power take-off can be effected hydraulically. In addition loading procedures can be controlled by remote means, by the vehicle operator, or by the collector cart operator.

In the carriage of lengths of plant materials, processing and carriage zones within the vehicle can include auger and/or conveyor belt arrangements and, for plant fragments, can further include blowers and ducts which can be made adjustable to direct plant fragments into collection carts.

According to another aspect of the invention, harvested plant fragment material (cellulose fibre) is treated locally at a farm to initiate processes that will be completed at a remote processing facility. In such a farm-located process, the fragmented plant material is tightly packed and the packed material is subjected to a water-acid-yeast solution to bring moisture to a desired level and to initiate fermentation. Subsequently, the mix of plant fragments and water-acid-yeast is loaded as slurry into a holding tank and left to ferment for a period of time. The fermented material is then filtered or otherwise processed to separate solid cellulose fiber waste from ethanol-bearing juice. The fermented material can in fact be subjected to several such fermentation steps and can be subjected to squeezing to increase the yield of the ethanol-bearing juice.

Preferably, following temporary storage and inspection, separated cellulose fiber waste is disposed as ground nutrient while leeched ethanol-bearing juices are stored prior to being transported by tanker away from the farm to a further processing facility. The slurry can alternatively be filtered at the time that it is pumped from farm storage to the tanker transport by separation means mounted on the tanker transport.

An advantage of splitting processing between these locales is that ethanol-bearing material is at least part-processed on the farm instead of being trucked to a dedicated ethanol processing plant. This represents a saving in transportation costs and storage compared with doing all processing at a central facility. Local processing also has other advantages. By locally separating off and disposing of the cellulose solid waste, there is no wasted back and forth journey for the solid component. Also there is a much reduced problem of solid waste disposal at the central facility, and, as a corollary, there is a direct return of valuable organic material to the earth at the farm. Moreover, there are reduced central storage needs and fire hazards.

In combination with farm-located processing, a central facility can include further storage and processing plant for handling ethanol-bearing juice transported from outlying farms. The central facility may also include a central managing function which can be used for monitoring and controlling operations at one or both of the central facility and, remotely, the outlying farms. Such remote monitoring can include security, plant integrity, etc., as well as assessing the stage of processing and expected delivery time and volume of ethanol-bearing juice to be delivered from the respective farms. At the central facility, incoming deliveries of ethanol-bearing juice can be batch analyzed to assess how further processing can be optimized for the particular composition of each ethanol-bearing juice since the juices vary from farm to farm depending, for example, on the composition of the starter crop.

As part of the processing, the ethanol-bearing juice at the central facility can be subjected to both drying to remove part of the water content and to further fermentation. Additives including fermenting yeasts can be injected as selected recipes to optimize the mixture for further fermentation, processing and refining of the ethanol-bearing juice. Once fermentation is complete, more water can be removed.

Capital and running costs for the overall ethanol production process can be significantly reduced by having plant material processing split between different sites as described.

### BRIEF DESCRIPTION OF THE DRAWINGS

For simplicity and clarity of illustration, elements illustrated in the following figures are not drawn to a common scale and dimensions of some elements may be exaggerated relative to other elements for clarity. Advantages, features and characteristics of the present invention, as well as methods, operation and functions of related elements of structures embodying the invention, will become apparent upon consideration of the following description and claims with reference to the accompanying drawings, all of which form a part of the specification, wherein like reference numerals may designate corresponding parts in the various figures, and wherein:

FIG. 1 is a side view of part of a harvester according to an embodiment of the invention.

FIG. 2 is a perspective view of part of a tool head according to an embodiment of the invention.

FIG. 3 is a scrap sectional view showing part of a chopping unit according to an embodiment of the invention.

FIG. 4 is a side view of part of a chopping unit according to an embodiment of the invention.

FIG. 5 is a side view of part of a harvester arrangement according to an embodiment of the invention.

FIG. 6 is a top view of the arrangement of FIG. 5.

FIG. 7 is a perspective view of part of a tool head according to an embodiment of the invention.

FIG. 8 is a side view of part of a harvester arrangement according to an embodiment of the invention.

FIG. 9 is a perspective view of part of a tool head according to an embodiment of the invention.

FIG. 10 is a perspective view of part of a tool head according to an embodiment of the invention.

FIG. 11 is a perspective view of part of a tool head according to an embodiment of the invention.

FIG. 12 is a perspective view of part of a tool head according to an embodiment of the invention.

FIG. 13 is a perspective view of part of a tool head according to an embodiment of the invention.

FIG. 14 is a side view of part of a harvester arrangement according to an embodiment of the invention.

FIG. 15 is a plan view of a tool head mounting arrangement according to an embodiment of the invention.

FIG. 16 is a plan view of a tool head mounting arrangement according to another embodiment of the invention.

FIG. 17 is a plan view of part of a tool head mounting arrangement according to a further embodiment of the invention.

FIG. 18 is a plan view of a harvester towing arrangement according to an embodiment of the invention.

FIG. 19 is a side view of part of a plant fragment production facility according to an embodiment of the invention.

FIG. 20 is a perspective view of a rasp type tool head according to an embodiment of the invention.

FIG. 21 is an end view of part of the rasp type tool head of FIG. 20.

FIG. 22 is a side view of part of a tool head according to an embodiment of the invention.

FIG. 23 is an end view of the tool head of FIG. 22.

FIG. 24 is a perspective view of part of a tool head according to an embodiment of the invention.

FIG. 25 is a perspective view of part of a tool head according to an embodiment of the invention.

FIG. 26 is a side view of part of a tool head according to an embodiment of the invention.

FIG. 27 is an end view of the tool head of FIG. 26.

FIG. 28 is a perspective view of a harvester according to an aspect of the invention.

FIG. 29 is part of a bale processing system according to an embodiment of the invention.

FIG. 30 is a perspective view of equipment according to an embodiment of the invention for collecting harvested plant fragments in the field and transporting them to a processing facility.

FIG. 31 is a front view of the equipment of FIG. 30.

FIG. 32 is a rear view of the equipment of FIG. 30.

FIG. 33 is a top view with part cut away of the equipment of FIG. 30.

FIG. 34 is a side view with part cut away of the equipment of FIG. 30.

FIG. 35 is a side view of a variation of the equipment of FIG. 30 forming another embodiment of the invention.

FIG. 36 is a perspective view of another embodiment of equipment for collecting harvested plant fragments in the field and transporting them to a processing facility.

FIG. 37 is a rear view with part cut away and part in phantom of the equipment of FIG. 36.

FIG. 38 is a perspective view of one embodiment of equipment for collecting harvested plant fragments in the field and transporting them to a processing facility.

FIG. 39 is a perspective view showing an arrangement, according to an embodiment of the invention, of certain components of the equipment of FIG. 38.

FIG. 40 is a perspective view of a farm facility for intermediate processing of plant fragments for bio-fuel processing according to a further aspect of the invention.

FIG. 41 is a perspective view of part of packing equipment at a farm facility, the packing equipment being according to one embodiment of the invention and being used in the course of a process for producing bio-fuel from plant fragments.

FIG. 42 is a side view showing the packing equipment of FIG. 41 in use.

FIG. 43 is a perspective view of one embodiment of a large scale facility for handling plant fragment material intermediate it being harvested and being transported to a chemical treatment processing plant.

FIG. 44 is a process sequence diagram for a part of an ethanol production process according to an embodiment of the invention.

FIG. 45 is a process sequence diagram for another part of an ethanol production process according to an embodiment of the invention.

### DETAILED DESCRIPTION OF THE INVENTION INCLUDING THE PRESENTLY PREFERRED EMBODIMENTS

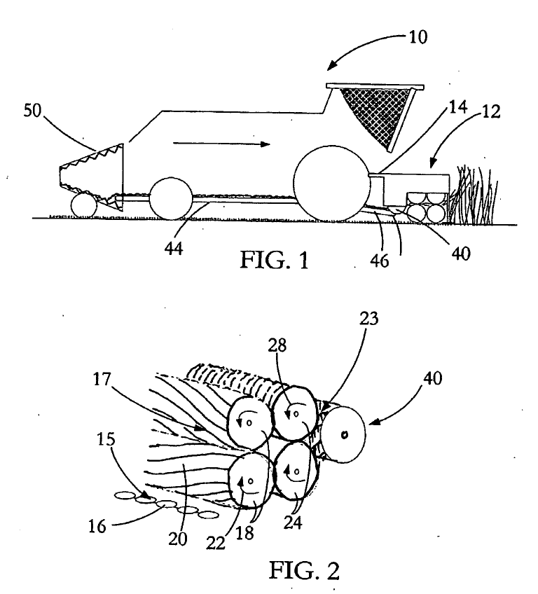

Referring to FIG. 1, a vehicular harvester 10 for harvesting a crop such as switch grass is shown in side view, the harvester 10 having a tool head 12 mounted to a frame 14. The frame 14 is mounted in front of a harvester cab in the harvester drive direction with the rear of the frame mounted to a body part of the harvester.

As shown in greater detail in FIG. 2, one form of tool head 12 has a cutter unit 15, a conditioning unit 17, a chopping unit 23, and an auger unit 40. Cutters 16 on the cutter unit 15 are disc shaped blades of the order of 12 inches in diameter having alternating teeth and notches formed around their circumferences. The disc cutters are mounted on generally vertical shafts driven from the harvester engine, the frame 14 maintaining the blades of the cutters 16 at an adjustable desired height above the ground depending on the length of an upper part of a standing plant that is to be taken for use in biofuel production and the length of a lower, ground-anchored root part of the cropped plant material that is to be left to eventually be ploughed back into the ground to restore organic content. In an alternative embodiment, each cutter 16 has a central shaft and a series of flail knives hingedly mounted on the shaft, the knives being of straight or sickle-shaped form.

Behind the cutter unit 15 in the harvester drive direction is mounted the conditioning unit 17 which has a pair of conditioning rollers 18. Each conditioning roller 18 has a shaft rotatable about a longitudinal axis, the axes of the conditioning rollers 18 being parallel to one another. The conditioning rollers 18 are of the order of 18 inches in diameter and may range up to 25 feet in length depending on the size and capacity of the harvester. Surfaces of the conditioning rollers are spirally fluted as shown at 20. The conditioning rollers 18 are driven in counter rotation as shown by arrows 22 from the harvester primary drive unit (not shown). With the frame 14 mounted in place on the harvester 10, the lowest part of the lower conditioning roller 18 is suspended about two inches above the surface of the ground.

Behind the conditioning unit, the chopping unit 23 has a pair of chopping rollers 24. Each chopping roller has a shaft rotatable about a longitudinal axis, the axes of the rollers 24 being parallel to one another. The chopping rollers are driven from the harvester engine in counter rotation about their respective longitudinal axes as shown by arrows 28. The chopping rollers are rotated at about 3000 revolutions per minute, although the rotation rate can be adjusted up or down depending on the nature of the plant material being cut and the strength and integrity of the roller construction.

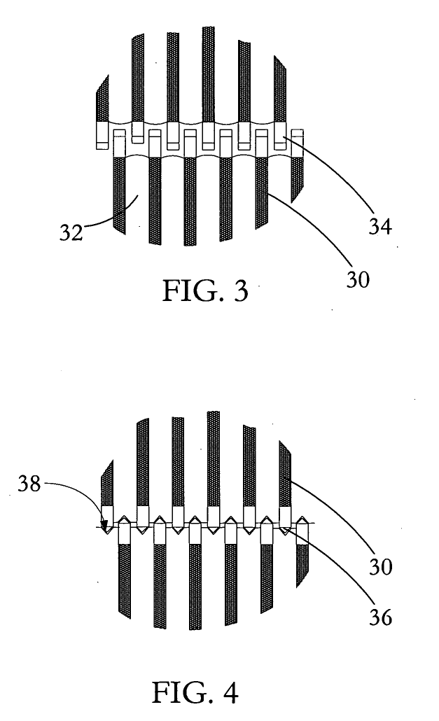

Referring to FIG. 3, there is shown part of the pair of chopping rollers 24 of FIG. 2. Each chopping roller 24 has a series of alternating annular blades 30 and spacers 32 keyed to a spline on a shaft (not shown). The blades 30 have an external diameter of the order of 18 inches and are made of high tensile STS steel about an eighth inch in thickness. Each blade has teeth 34 distributed around its circumference, of which one is shown for each blade illustrated in FIG. 3, typically six teeth per blade. The teeth are tipped with diamond or carbide to reduce wear.

The spacers 32 are made of nylon or steel and are of reduced diameter compared to the diameter of the blades 30 so that each blade 30 of one roller 24 loosely meshes with a spacer 32 of the opposed roller 24. The spacers 32 are of the order of a half inch in thickness and each spacer has chain saw cutters 36 welded into its circumference.

The chopping unit 23 includes an adjustment mechanism (not shown) to alter the spacing of the axes of the chopping rollers 24 so as to alter the spacing of the teeth 34 on one of the rollers 24 and abutment edges of the spacer 32 on the other roller 24 at a chopping zone where the opposed chopping rollers 24 are at their closest. The spacing is selected to obtain a desired fragment length and condition of plant material processed by the chopping rollers. The chopping rollers 24 have a diameter of the order of 18 inches, although a larger diameter can be adopted to increase the angular momentum of the rollers or a smaller diameter adopted to reduce stress on the roller mounting arrangement.

In the FIG. 3 embodiment, the teeth 34 are generally square cut. An alternative embodiment showing one pairing of a blade 30 and one spacer 32 is shown in FIG. 4 and in this embodiment, teeth 36 are formed with a V-section and the profile of the opposed spacer has a corresponding V-section recess 38. The form of tooth on the blades 30 is chosen to obtain plant fragments with reduced grinding action so as to produce less plant material in granular or dust form.

Referring again to FIG. 2, the fore aft clearance between the pair of conditioning rollers 18 and the pair of chopping rollers 24 is chosen to ensure that most of the plant material fed by the conditioning rollers will enter a throat section between the pair of chopping rollers 24. The frame 14 is suspended so that the lower extremity of the lower chopping roller is clear of the ground. The chopping rollers 24 are driven in counter rotation from the harvester primary drive unit (not shown) at a rate of about 3000 revolutions per minute which is greater than the rate of rotation of the conditioning rollers 18.

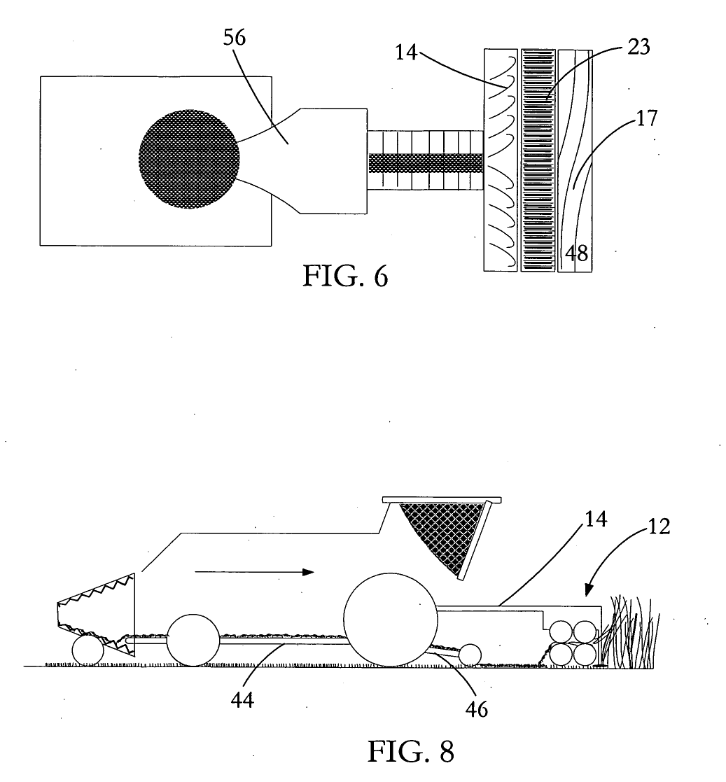

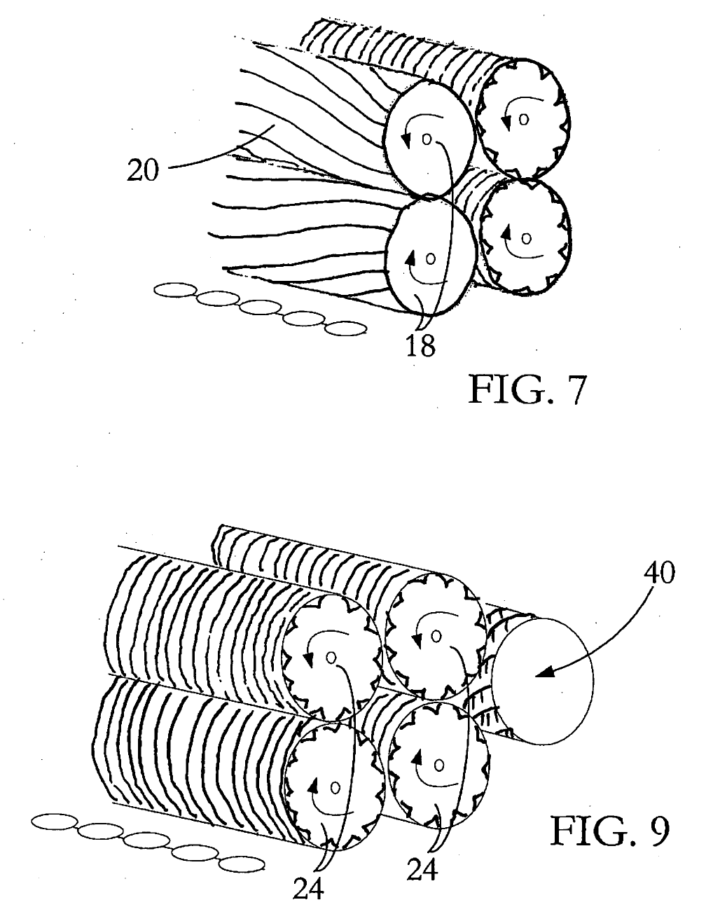

As shown in FIG. 6, an auger 40 is mounted behind the pair of chopping rollers. The auger is suspended from the frame 14 at a position where its axis of rotation is generally level with a throat region 42 between the two chopping rollers 24. The auger 40 has sections of opposite hand so that its rotation drives material captured by the auger 40 in towards the centre of the harvester drive direction. The auger 40 is driven from the harvester primary drive unit (not shown) at a slower rate of rotation than the chopping rollers. As is known in the auger art, pop-up pins and flighting on the auger ensure that fragments of plant material fed towards the centre of the auger by the auger's rotation do not bunch up.

Returning to FIG. 1, mounted behind the tool head 12 in the harvester drive direction is a continuous chain conveyor 44. The conveyor 44 is driven from the harvester primary drive unit (not shown) and has a forward section 46 sloping downwardly towards the ground in the harvester drive direction. A leading edge 48 of the forward section 46 is located to receive fragmented plant material ejected from the auger 40. A conical auger 50 suspended behind the chain conveyor is positioned to receive material conveyed by the conveyor 44.

In operation, as the vehicular harvester 10 is driven forwardly, the series of cutters 16 acts to cut biofuel crop such as switch grass as the harvester moves forward. The cut plant material falls against the lower one of the conditioning rollers 18 and from there, is drawn into a throat section of the pair of conditioning rollers. The spiral fluting 20 on the conditioning rollers 18 acts to reorientate the falling stems towards the axes of the rollers. The conditioning rollers 18 also act to meter the delivery of plant material to the pair of chopping rollers 24 so that the chopping rollers 24, spinning in the order of 3000 revolutions per minute, are handling at most a few stems of plant material at a time. The switch grass swept into the chopping rollers 24 is chopped by the opposed teeth of the rollers and is then ejected from the throat section 42 to the auger 40. The auger 40 draws the cut fragments of switch grass towards the centre line of travel of the harvester before dropping them onto the front edge 48 of the chain conveyor 44. The conveyor 44 conveys the fragmented material rearwardly to drop it into the conical auger 50.

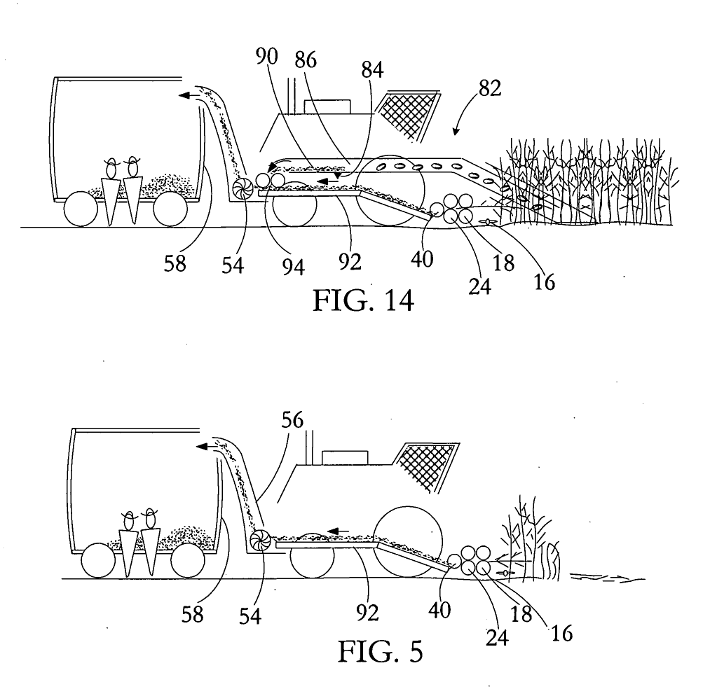

In an alternative embodiment as shown in FIGS. 5 and 6, the conical auger is not used. Instead, the conveyor 44 conveys fragmented plant material into a high capacity blower 54. The blower 54 is housed in a funneling collection chute 56, and blows the plant fragments up into a chute, the ground plant material subsequently falling from an output end of the chute 56 into a trailing cart 58. Alternatively, the chute 56 can be dispensed with and the plant fragments are simply blown through the air to the trailing cart 58.

Several variations of the illustrated arrangements are possible in term of the presence and positioning of various elements of the tool head 12. It will be understood that all of the variations of tool head illustrated and described herein can be implemented as a series of detachably interconnected modules, the particular selection of module depending on tuning the processing to the plant material being harvested.

A variation shown in FIG. 8 is particularly adapted for harvesting plant material from a previously cut swath as opposed to a standing crop. In this embodiment, the tool head has no cutting unit. Instead, the movement of the lower conditioning roller 18 over the swath picks up the swath essentially as a continuous mat and feeds it to the rollers 24 of the chopping unit. The lower conditioning roller has sprung pins mounted along its length which, in use, locate under the swath material to lift it clear of the ground to enable the conditioning rollers to deliver it to the chopping unit.

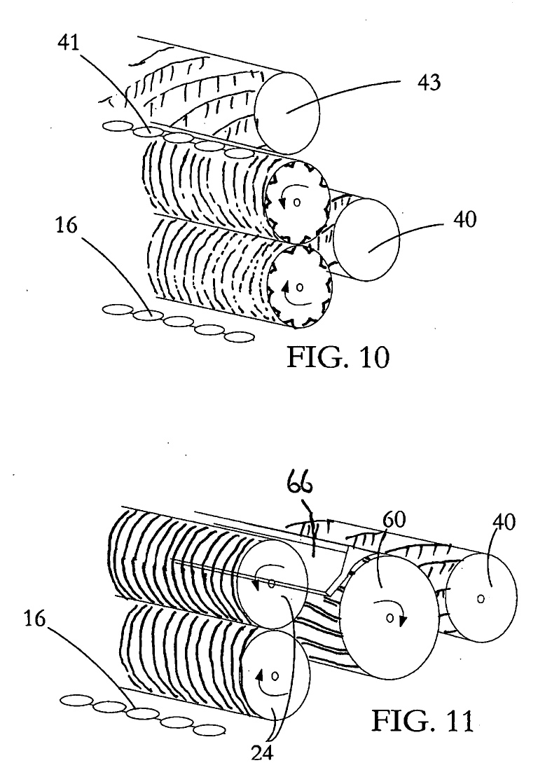

Further embodiments of tool head are shown in perspective view in FIGS. 9 to 13. The embodiment of FIG. 9 has two identical pairs of chopping rollers 24 mounted on the frame (not shown) with the auger 40 trailing the rearmost pair. In this arrangement, plant material is chopped between a front pair of chopping rollers 24 and is then ejected into a throat section between rear chopping rollers 24 to be chopped again. Such an arrangement is used if processing by a single pair of chopping rollers does not produce sufficient fragmentation of the plant material. In the embodiment of FIG. 10, no conditioning rollers are used and, in operation, only the plant material which drops at the throat region between the chopping roller is taken up and delivered to the chopping rollers. FIG. 10 is also characterized by an additional set of cutters 41 which are mounted in a manner similar to the set of cutters 16 but above the rollers of the tool head 12 and forwardly of the tool head in the drive direction so that the upper cutters cut into a particular plant marginally before the lower cutters 16. Behind the cutters 41 in the sense of the drive direction of the harvester is a further auger 43. Although not shown in FIG. 10, a set of conditioning rollers can be mounted between the upper cutters and the upper auger to improve the presentation of cut stem materials to the upper auger. Any of the other tool heads illustrated in the accompanying FIGS. can also include such an additional set of cutters and auger. This particular tool head arrangement is of value in relation to an embodiment of the invention to be described presently with respect to FIG. 14 and in relation to preparing primary crop and secondary bio-fuel crop for grain bearing plants.

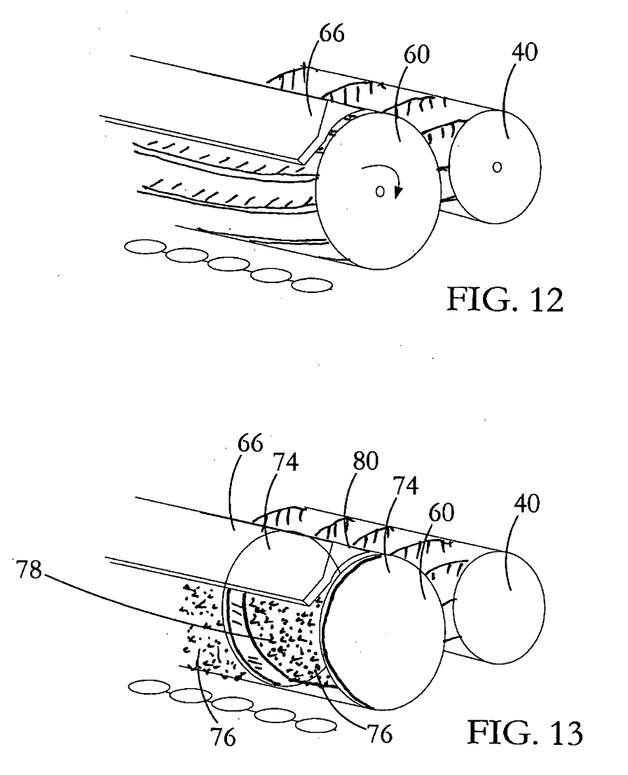

In the embodiment of FIG. 11, in addition to the chopping rollers 24, the arrangement has a clipping roller 60 with laterally extending blades 62. The clipping roller 60 functions in a manner similar to a push mower cutter and rotates against a cutting blade 66. The clipping roller 60 is driven from the harvester primary drive unit (not shown). As in the other examples of chopping head 12, the efficiency of the FIG. 11 unit depends on the clipping roller 60 rotating at very high speed and depends also on a throughput of plant material that is never so high as to cause the clipping roller 60 to slow materially from an optimal rate of rotation. FIG. 12 shows yet another alternative tool head 12, this head having no chopping rollers at all but having only a clipping roller 60 and cutting blade 66 arrangement of the sort shown in FIG. 11.

By having the rotary cutting elements, whether the opposed chopping rollers 24 or the clipping rollers 60, rotating at very high speed, the large angular momentum of the rollers are harnessed in the manner of a flywheel. The momentum depends on the rate of rotation and roller weight distribution about its spin axis. Ideally a high level of “flywheel” effect is obtained but not so high as to cause untenable stresses in the chopping rollers or their mounting arrangement.

FIG. 13 shows part of a further alternative tool head which operates with a rasping action. The tool head has a leading set of cutters 16 and a trailing auger 40 as in several of the previously illustrated embodiments. In this embodiment, however, keyed to a roller shaft 72 is a series of alternating blades 74 and rasp sections 76. The blades 74 are the same as the blades 30 illustrated in the FIG. 2 embodiment. The rasp sections 76 are made of hard steel with surface areas formed with projections 78. As mounted, the rasp sections 76 have their projections passing close to an adjacently mounted stationary blade 80 which presents an abutment edge. The closely spaced projections 78 acting against the abutment edge of the blade 80 tend to shear plant stem material as the rasp sections spin at high speed.

Each of the tool head arrangements is designed and dimensioned to achieve a chopped plant fragment length of the order of one quarter of an inch although, depending on subsequent chemical processing, the tool head can be adapted to produce longer lengths of the order of an inch. These lengths are preferred as a compromise between, on the one hand, presenting a large surface area to fluids within which the fragments are immersed during subsequent chemical treatment and, on the other hand, avoiding the fragments being treated from becoming a hard-to-manage sludge which may happen if the fragments are too small and approach the size of grains or dust.

For certain purposes, larger plant lengths are desirable. In some circumstances, if plant material is fragmented, collected and baled in an essentially continuous process, a high moisture content in fragmented plant material may mean that the bales are difficult and expensive to lift and carry. If the plant material is densely packed, it may be slow to dry out. In these circumstances, the harvesting and preparation of the plant material is done in several stages: cutting the standing plants to obtain plant material of a length intermediate the standing plant height and fragments, leaving the intermediate lengths in the field to dry, collecting the dried plant lengths, and then processing the collected intermediate lengths to form plant fragments.

For the cutting stage, in one embodiment, axes of the chopping rollers are held widely spaced. The lower roller does all the chopping of plant material which is directed into a wide throat region between the rollers, while the top roller idles. An advantage of this embodiment is that by altering spacing of the chopping rollers, a common set of the rollers can be used both for the intermediate processing to obtain the intermediate lengths of plant material and for later processing to produce the plant fragments. In an alternative embodiment, the blades of the chopping rollers are widely spaced, typically six inches or more, along the axes of the chopping rollers so that plant material exiting from between the chopping rollers tends to a length comparable to the blade spacing. When cut from standing plant stock, these intermediate length fragments are left in the field to dry until a satisfactory reduction in moisture content has been obtained to reduce the weight of the material to be handled in subsequent phases of the process. Subsequently, a second pass over the previously cut material is made to pick up and chop the laying plant material to the much smaller fragment lengths ready for biofuel chemical treatment.

FIG. 14 shows a vehicular harvester having a dual purpose function to collect and process a primary crop at a primary crop sub-system and to collect and process plant material for subsequent biofuel processing at a secondary crop sub-system. The example illustrated is particularly adapted for processing standing corn plants. The harvester has a primary cob cropper module 82 for breaking off cobs of corn in known manner as the harvester moves through a corn field. The cob cropper 82 breaks off cobs of corn and drops them onto an upper chain conveyor 84 which conveys the corn cobs through an upper chamber. Housed in the upper chamber is a dehusking mechanism 86 which takes the corn cobs and strips them of husk material. Cobs are loaded into a bin 88 and husk material 90 continues along the conveyor 84.

As the harvester advances, shortly after a standing corn plant has been stripped of cobs, the stem of the plant is cut by the spinning cutters 16 of the tool head 12 which can be of any of the forms previously described. The cutters are held at a height chosen by the operator to leave a lower part of the plant of whatever length is desired to return organic nourishment to the earth. The cut stems are drawn into a throat section between a pair of conditioning rollers 18, which eject the stems into a throat section of a pair of chopping rollers 24. In another embodiment (not shown), conditioning rollers 18 are not used and the cut stems fall directly into the throat region between the pair of chopping rollers. The plant fragments are ejected by the chopping rollers into the auger 40 and are delivered by the auger 40 to a lower chain conveyor 92. The lower chain conveyor 92 conveys the fragments rearwardly towards the blower 54 which is operable to blow the plant fragments up through the funneling chute 56 and into the trailing cart 58 as previously described with reference to FIG. 5. In the FIG. 14 embodiment, a further series of auxiliary chopping rollers 94 is located immediately in front of and above the blower 54. Husk material 90 separated from the cobs is dropped from the end of the belt conveyor 84 and falls into a throat section between the two auxiliary chopping rollers 94 where it is chopped into fragments before being dropped out of the auxiliary grinding rollers 94 to join the bulk of the fragmented plant material being conveyed by the lower chain conveyor 92.

The dual purpose crop and biofuel harvester arrangement can be adapted for different crops such as wheat. In the case of wheat, a first cutter cuts a top part of the wheat plants. The top parts of the wheat plants are then fed through an upper processing zone to separate the wheat grain from chaff in known fashion and to thresh the ears of wheat. The chaff is fed to the rear of the upper processing zone and then dropped out of the harvester as a swath or rejoins material being conveyed through the lower processing zone. A second cutter reaches a particular plant of the standing wheat at the same time or shortly after the first cutter has cut the top part of the plant, and then cuts a bottom part of the plant. The lower cut is positioned as in the case of the corn plant cutting to leave a desired root portion still standing to be later ploughed into the soil, but collects the intermediate length of plant stem which is conveyed through the lower processing zone. The harvester includes an adjustment mechanism to alter the relative lengths of the upper, lower and root portion depending on what length of upper part is required to obtain the particular grain or other crop, what length of the lower part is desired for biofuel processing, and what length of root portion it is desired to be ploughed back into the ground to provide nourishment

As in the case of corn, the lower zone either completes the process to produce the quarter inch plant fragments and to eject them into a collection cart or leaves the plant stems in larger lengths of the order of several inches to a foot which are dropped from the harvester onto the field as a swath. The swath is allowed to dry for several days before being picked up either for final processing to fragments in the field or to be baled for processing into fragments at a remote location.

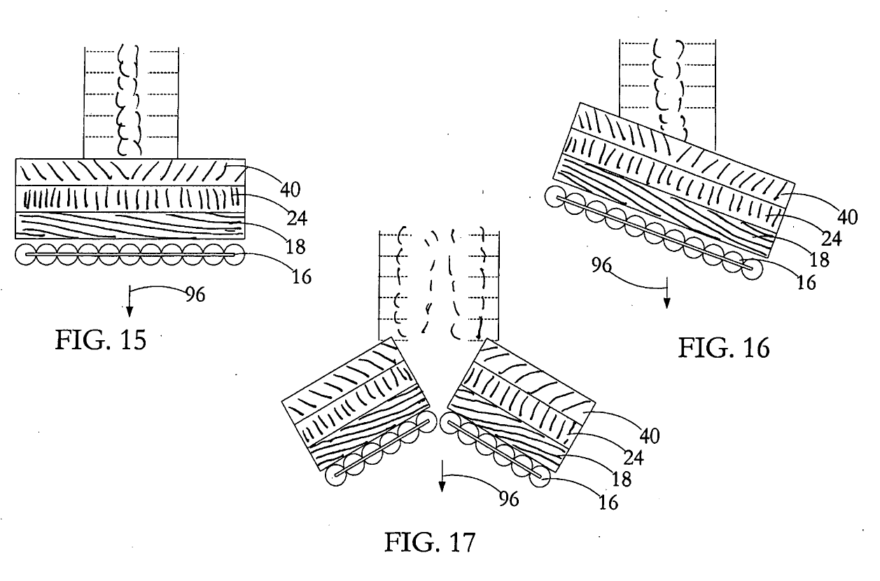

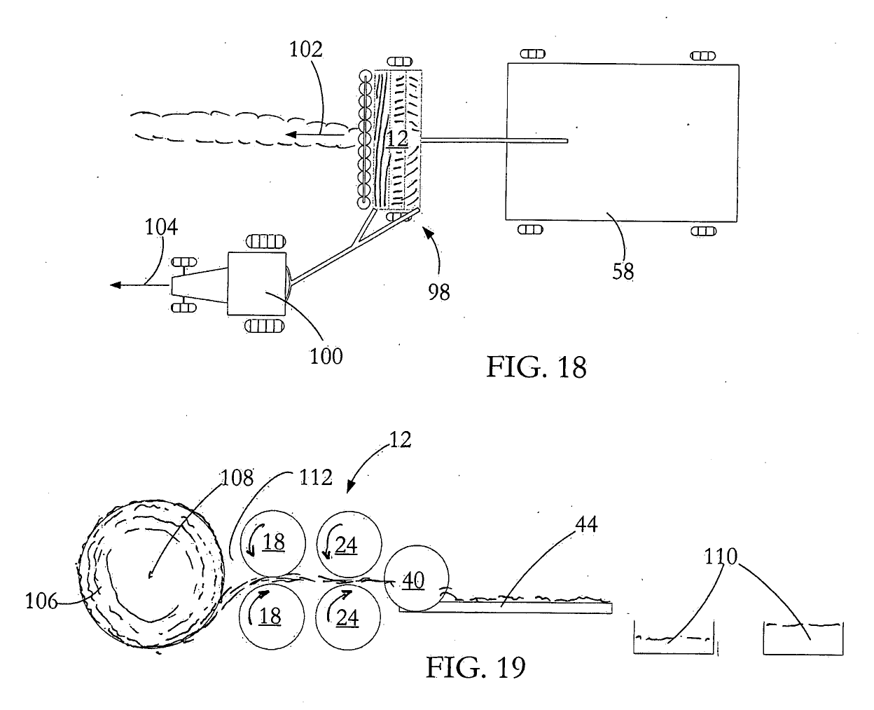

Referring to FIGS. 15, 16 and 17, there are shown plan views of three different embodiments of tool head for mounting on a vehicular harvester. In each case, the harvester drive direction is shown as arrow 96. The tool heads each have stem cutters 16, conditioning rollers 18, chopping rollers 24, and an auger 40. In the FIG. 15 embodiment, the tool head is mounted with the axis of the chopping rollers 24 extending perpendicular to the harvester drive direction 96. In the FIG. 16 embodiment, the tool head is mounted at an angle to the harvester drive direction 96. In the FIG. 17 embodiment, the tool head is formed in two sections with the sections being mounted so that the crop plant material harvested is drawn into a V-formation between the tool head sections as the harvester advances, and with the augers having opposite hand. As shown in FIG. 18, as an alternative to harvested plant material being drawn into and through a harvester, a mobile harvesting module 98 includes a tool head 12 of any of the designs described previously, and a trailing cart 58 for collecting processed plant material, these being mounted to a tractor unit 100 and pulled along a harvesting route 102 which is offset from a route 104 followed by the tractor unit.

Although the previously described embodiments of the invention have application predominantly to vehicular harvesters used in the field, other embodiments of the invention find application in a fixed site such as a bale processing facility.

Referring to FIG. 19, a cylindrical bale 106 of plant material which has been collected from the field but has not been fragmented is suspended to permit rotation about its longitudinal axis 108. Close to the bale is a tool head 12 of the form illustrated in FIG. 2, having a pair of conditioning rollers 18, a pair of chopping rollers 24, and an auger 40. The auger 40 is located to eject plant material fragments onto a chain conveyor 44 which conveys the plant fragments to collection bins 110. The tool head 12 is mounted on a supporting frame (not shown). In operation, the bale 106 is rotated about its axis by a rotary drive mechanism (not shown) and a web 112 of plant material is lifted from the bulk of the bale 106. The web 112 is started by applying a knife (not shown) generally tangentially to the outer surface of the bale in a peeling action and then moving the knife along the length of the bale 106. The starting part of the web 112 is fed to the throat section of the pair of conditioning rollers 18. The bale 106 is rotated about its axis at a predetermined rate matched to the speed of rotation of conditioning rollers 18. By pulling the starting part of the web 112, further plant material is drawn from the bale. Such a web 112 can alternatively be started by bringing the bale 106 and the tool head 12 close together by reciprocating means (not shown) so that a top layer of the bale 106 is grabbed by the throat section of the conditioning rollers 18. Once the web is started, the separation of the bale 106 and the tool head 12 is increased.

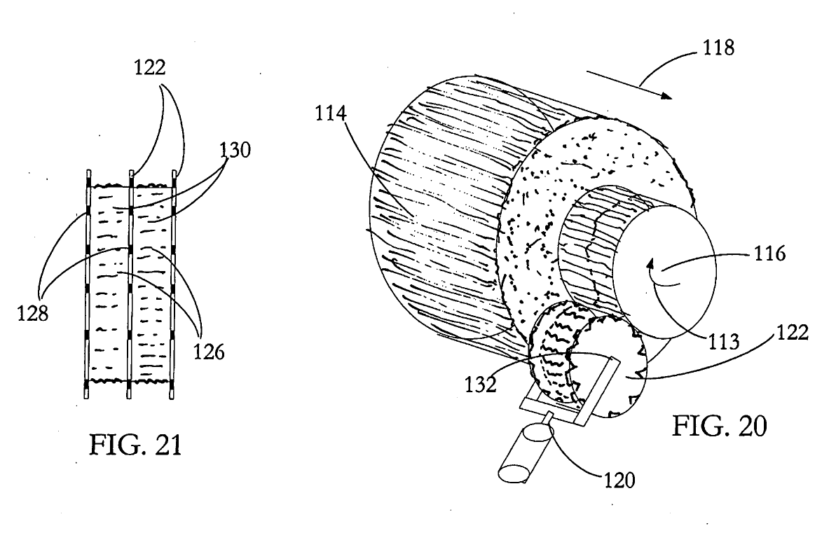

FIG. 20 shows an alternative embodiment of the invention for fixed site use. As shown by arrow 113, a bale 114 is rotated about its longitudinal axis 116 by a rotary drive mechanism (not shown). In addition, the bale 114 is periodically step driven in the direction of arrow 118 by a translational drive mechanism (not shown). Mounted at the end of an actuating arm 120 is a high speed clipping head 122 which, as shown in greater detail in FIG. 21, includes circular blades 124 and a relatively reduced diameter spacer 126 intermediate each pair of blades. The blades have teeth 128 formed around their circumference, the teeth having diamond or carbide tips to prolong wear. A series of chain saw cutters 130 is mounted around the outer cylindrical surface of the spacers 126. The clipping head 122 is rotatable about an axis 132 by a chain and sprocket drive from a primary drive unit (not shown). The actuating arm includes a piston and cylinder arrangement (not shown) to drive the clipping head 122 in a reciprocating motion towards and away from the axis 116 of the bale. In use, the clipping head 122 is driven to a location spaced from the bale 114 and the bale 114 is stepped along its axis to a first chopping position. Rotation of the bale 114 about its axis as shown by arrow 113 is initiated and rapid rotation of the clipping head 122 is also initiated. The clipping head 122 is then moved by the actuating arm 120 towards the axis 116 of the bale. The rate of rotation of the bale 114 and the rate at which the clipping head 122 is driven towards the bale axis 116 are selected so that for the particular plant material, fragments of a desired size are produced and, at the same time, the rate of rotation of the clipping head 122 is not materially reduced by engagement of the clipping head 122 with too great an amount of bale material.

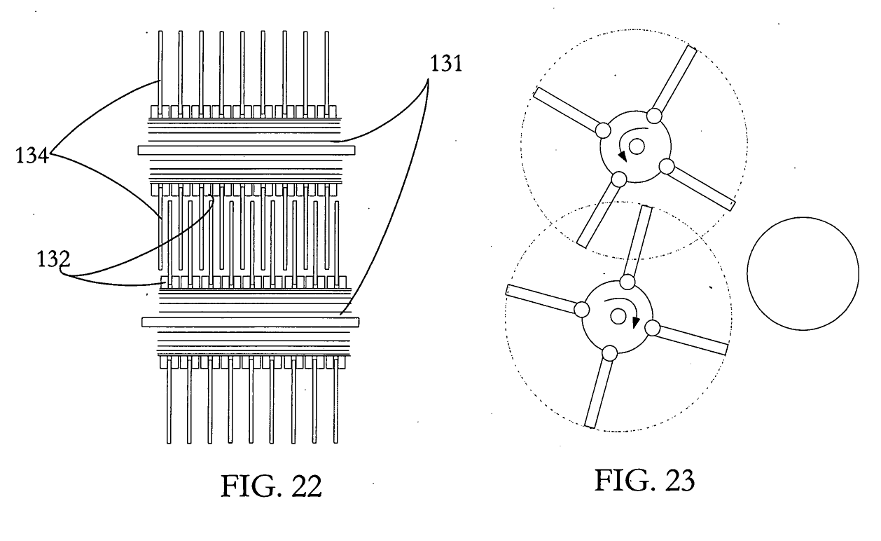

As shown in the variation of FIG. 22, a tool head 12 has two parallel 6 inch diameter pipe shafts 131, each shaft 131 having welded lugs 133 to which are hinged opposed pairs of knives 134 each of the order of 3 inches in length. The knives 134 are made of high tensile steel and of the order of one eighth inch in thickness and at half inch spacing. The illustrated knives are straight but can alternatively be of sickle form. The knives 134 on the respective shafts 131 are located so that opposed knives 134 mesh together. The shafts 131 are driven in counter rotation so that plant material fed into a throat region between the knife equipped shafts 131 is processed to fragments of the order of a quarter inch in length before they are ejected to an auger 136 as shown in FIG. 23. The shafts are rotated at about 3000 revolutions per minute.

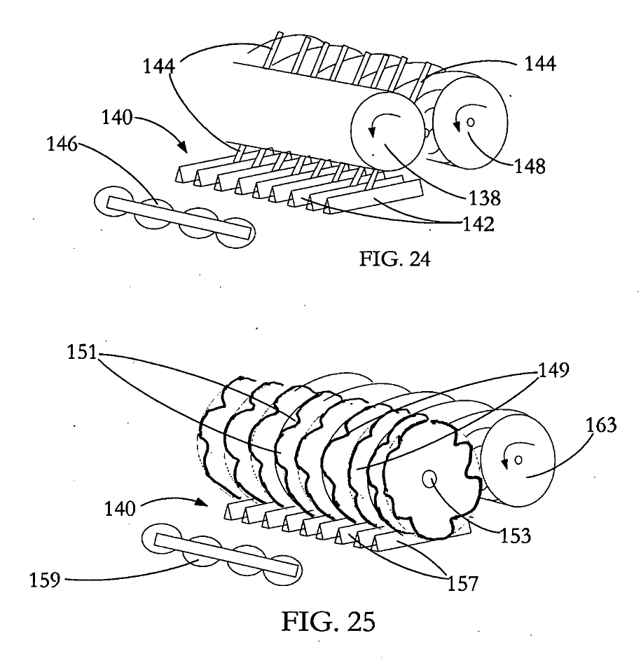

As shown in the variation of FIG. 24, a single rotating knife-bearing shaft 138 of a type similar to the knife bearing shafts of FIG. 22 is used. In place of the second shaft, a slotted grate 140 is mounted under the shaft 138, the grate 140 having a set of abutment bars 142 which mesh with knives 144 hinged to the shaft 138. In use, standing plants are cut by horizontal cutters 146 and fall into a throat section between the spinning knives 144 and the grate 140. The shaft is rotated at about 3000 revolutions per minute. The plant material is sliced by the knives 144 as the knives drive the plant material against the bars 142. After being chopped, the resulting plant fragments are ejected to a trailing auger 148. An adjustment mechanism (not shown) is used to adjust the spacing of the shaft 138 and the grate 140 to adjust the interaction between the knives and the bars. With a wide spacing, plant material is predominantly kinked and crushed while with a narrow spacing, the plant material is cut into small fragments.

In an alternative embodiment to the knives, the present invention contemplates, as shown in FIG. 25, a series of generally disk-shaped blades 149 which are of the order of 24 inches in diameter and have gullet regions 151. The blades 149 are mounted on a shaft 153, are of high tensile steel, and are of the order of one eighth inch in thickness. A slotted grate 155 is mounted under the shaft 153, the grate having a set of abutment bars 157 which mesh with the blades 149. In use, standing plants are cut by horizontal flail knife cutters 159 and fall into a throat section between the spinning blades 149 and the grate 155, the shaft being rotated at about 3000 revolutions per minute. The plant material is sliced by the blades 149 as they drive the plant material against the abutment bars 157 and the plant material enters and is chopped at the blade gullet regions 151. After being chopped, the resulting plant fragments are ejected to a trailing auger 163. An adjustment mechanism (not shown) is used to adjust the spacing of the shaft 153 and the grate 155 to adjust the interaction between the blades 149 and the abutment bars 157. With a wide spacing between the blades 149 and the abutment bars 18, plant material is predominantly kinked and crushed while with a narrow spacing, the plant material is chopped into small fragments. In addition, the spacing between adjacent blades 149 can be altered to increase the average length of the plant material fragments that are obtained after chopping.

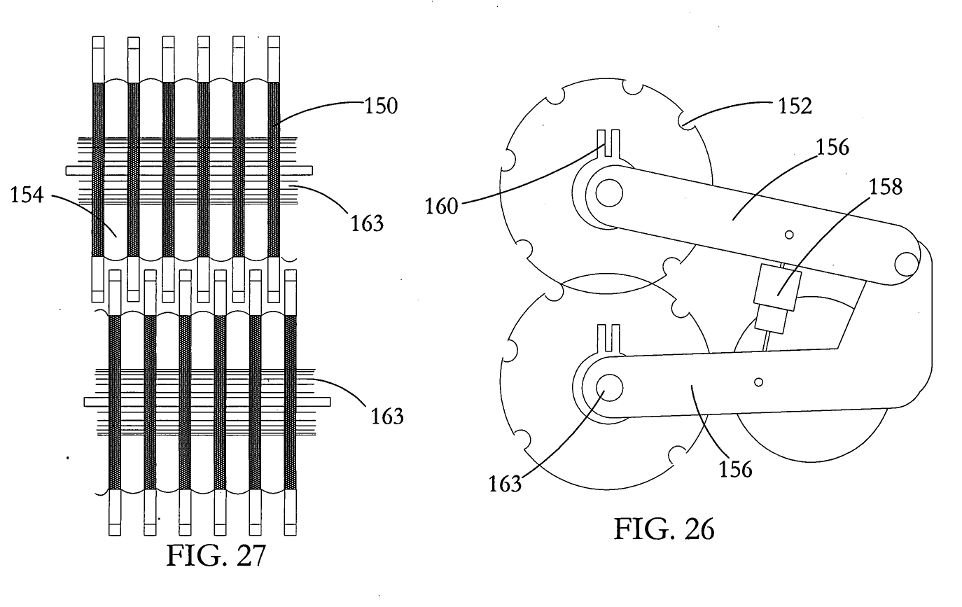

As shown in the variation of FIG. 26, a series of disc blades 150 having notches 152 around their circumferences are mounted on a pair of driven shafts 163 with intervening spacers 154 so that the blades 150 on one shaft mesh with the intervening spacers 154 on the other shaft. The shafts 163 are coupled through a hinged adjustment mechanism having arms 156 and an adjustment link 158. The link 158 can be a hand operated screw mechanism or can be a more complex arrangement such as a servo assisted hydraulic mechanism. The shafts 163 can be driven by a hydraulic drive through an orbital motor arrangement 160 in known fashion.

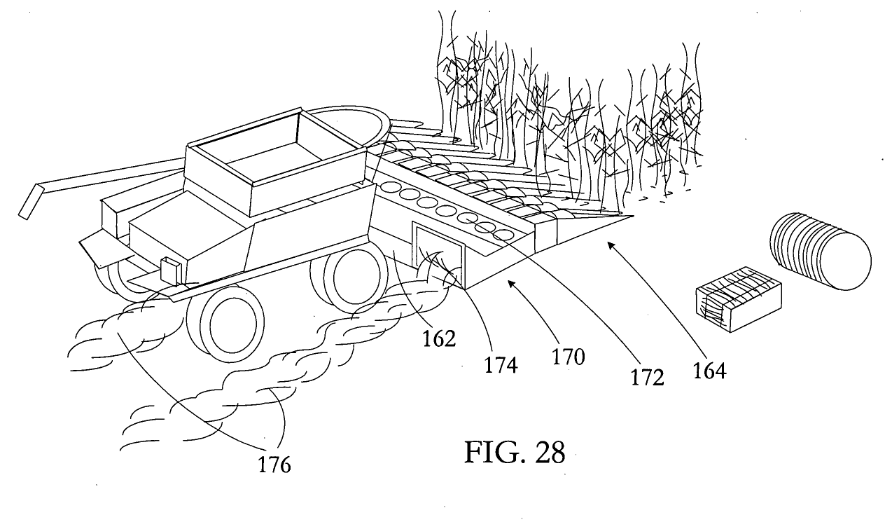

FIG. 28 shows a perspective view of a combine harvester according to a further aspect of the invention. In contrast, with the FIGS. 4 and 14 embodiments, plant material destined to be used for biofuel production is not harvested at the same time as the main crop, such as corn or wheat. Instead, the combine harvester operates in known manner to harvest the primary crop such as corn or wheat. However, in this embodiment, an extended feeder housing 162 is used between a primary tool head 164 and the main harvester body to accommodate a secondary tool head 170. The primary tool head 164 is a first stage in the harvesting of a first crop which typically may be corn or wheat and the secondary tool head 170 is the first stage in the harvesting of a second biofuel crop. The secondary head 170 is used to prepare the plant stem material which remains after a primary crop portion has been stripped or cut from the standing plant. In the case of crops such as corn, the secondary tool head 170 cuts the corn plant immediately after it has been stripped of cobs by the primary tool head 164. This is achieved with a series of flail knife cutters 172 which are of the same type as the knife bearing blades of FIG. 22, the knife cutters 172 however being mounted on vertical axes. The knife cutters 172 are mounted in an arrangement permitting the cutters 172 to be used at a chosen height by the harvester operator. This enables the harvester operator to decide what amount of the stem material will be left attached to the plant roots to be later ploughed back into the field to restore organic content and what amount will be cut and collected for biofuel production. The secondary tool head 170 processes the cut corn plant stems through a tool head module of any of the types shown previously except that the chopping rollers or knife bearing shafts have blades or knives positioned to obtain the particularly desired lengths of plant material and, if desired, to introduce a desired amount of crushing to encourage drying as previously described. The secondary tool head also includes an auger arrangement 174. By appropriately siting and timing the operation of pop-up pins and locating lighting which are known auger control devices, the plant material loaded into the auger 174 from the preceding elements of the secondary tool head can be directed from the auger 174 as a swath 176 (or as multiple swaths if desired) along a desired path parallel to the harvester drive direction. The benefit of leaving the plant material in swaths is that it allows drying of the plant material. In addition, when harvesting the primary crop, there is a large amount of machinery in the field including harvester and collection trucks. Consequently, it may not be desired to add biofuel collection and processing machinery to operate at the same time and in essentially the same location as the main crop harvesting machinery.

The secondary tool head will not always be used if the operator of the harvester is concerned only to harvest the primary crop. The secondary tool head may reach a length of 25 feet in a high capacity machine. For both these reasons, the secondary head is made to be readily detached from the combine.

Although this embodiment has been described with reference to corn in which corn cobs are removed discretely from the standing plants by the primary header before processing by the secondary header, grain crops such as wheat are processed in a similar fashion but using a different primary tool head. In this case the primary tool head cuts an upper part away from the standing plant. This is then conveyed in the harvester to an upper processing zone where there is sited a winnowing processor which operates in known fashion to separate the wheat from the chaff. The chaff is then directed by an auger or conveyor arrangement to join the lengths of plant material which have been processed at the secondary tool head as described previously and is eventually deposited as a swath for later collection and further processing.

Following drying, plant material from the swaths is collected and baled. Baling methods and mechanisms are known and will not be described in detail. However, generally, bales are formed in rectangular or cylindrical form. In each case, the bale is taken to a processing facility where it is treated by one of the chopping units described previously.

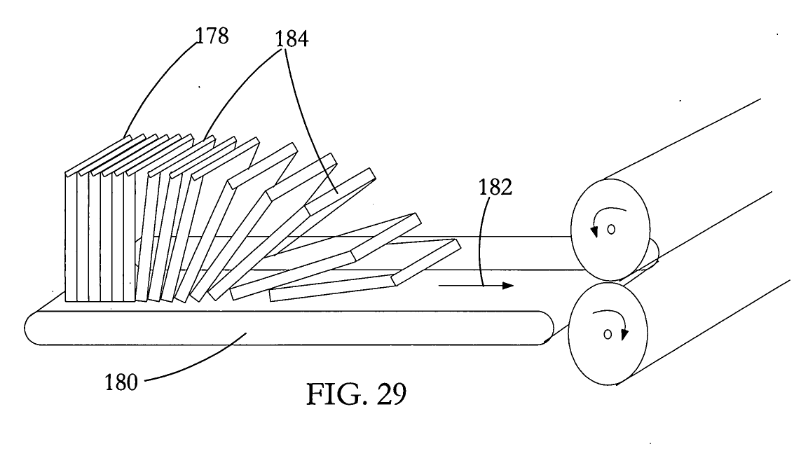

While previously described FIG. 19 shows one form of a bale processing system adapted for handling a cylindrical bale, FIG. 29 shows an alternative bale delivery and processing system adapted for a rectangular bale 178. As shown, a bale 178 is mounted above a chain conveyor 180 and is periodically stepped in the direction of arrow 182 parallel to the conveyor 180. At each stop in the stepping sequence, the bale 178 is sawn through by a reciprocating saw (not shown) which is mounted so as to attack the bale 178 vertically or laterally. The action of the saw detaches a layer 184 from the bale 178 which drops onto the chain conveyor 180 which conveys the layer 184 of plant material into a chopping unit of any of the forms described previously.

Although the above embodiments of the invention have been described with a view to obtaining plant fragments of the order of a quarter inch in length, some biofuel chemical treatment processes have been developed which are optimized for treating larger fragment such as a half and inch or more. It will be clear from the description of the embodiments described above that dimensions of the various tool head components can be altered to obtain plant fragments which are of larger size and yet within the range of fragment lengths suited for the particular biofuel production process.

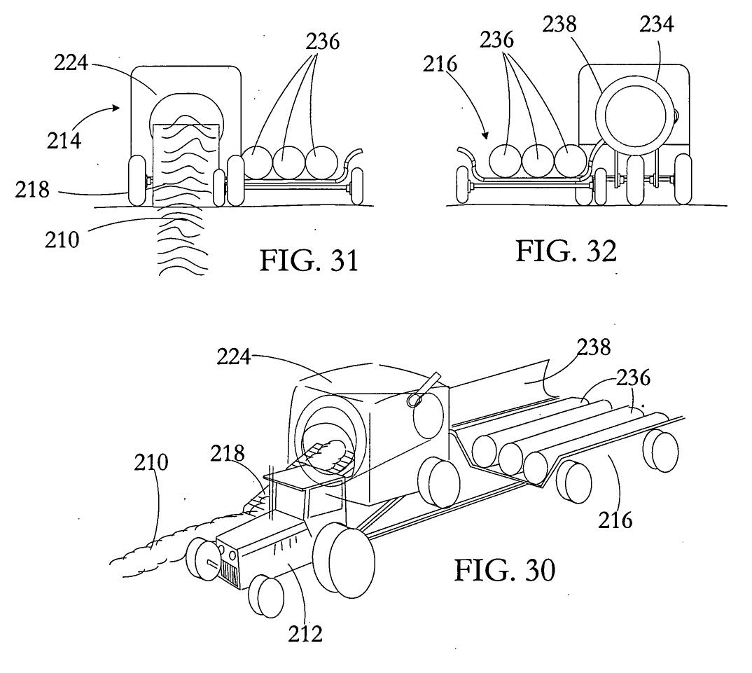

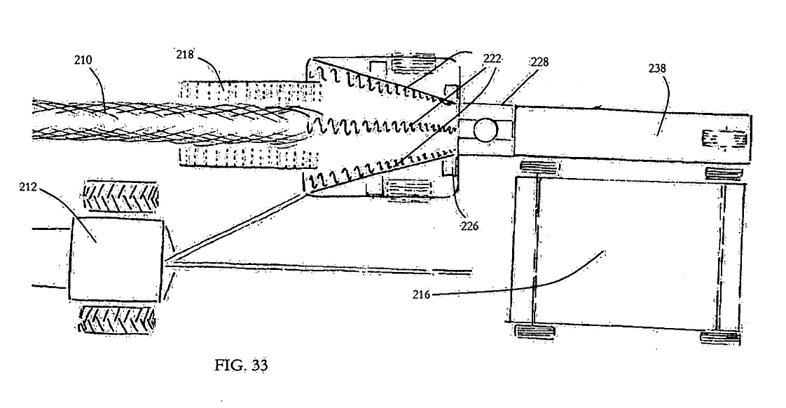

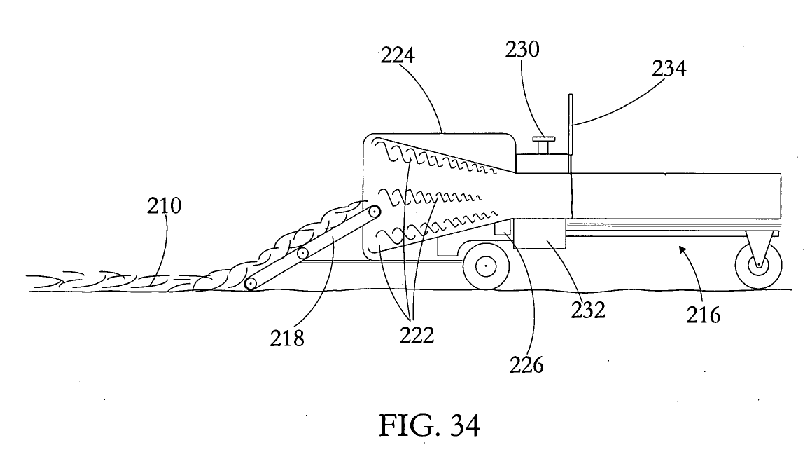

The arrangement of FIGS. 30-34 shows equipment for harvesting plant material from a swath 210 resulting after bio-fuel crop or food crop residue has previously been cut and left in the field for a period of time to dry. The equipment includes a tractor 212 to which is mounted both a preparation unit 214 and a temporary storage unit 216. The preparation unit is mounted off to one side of the travel line of the tractor 212. The preparation unit includes a chain conveyor 218 which is driven to pick up material from the swath 210 as the conveyor 218 passes over the swath 210 and to convey the material into an opening at one end of a conical auger housing 220. Mounted in the housing 220 are a series of augers 222, the augers 222 and housing 220 being themselves mounted in a protective vehicle cab 224. The augers 222 are rotated by an auger motor 226 to drive the incoming plant fragments from the larger opening at the lead end of the housing 220 to a smaller opening at the trailing end of the housing 220. The augers 222 act both to compact the fragments of material and to drive them compressed into the form of a cylinder from the front to the back of the auger housing 220.

To assist in compacting the plant material, the auger housing 220 is rotated about its fore-aft axis to impart a twist to the cylinder of fragmented plant material as it passes through and out of the housing 220 and into a roller unit 228. At the roller unit 228, a hydraulic driven hold-down roller 230 applies pressure to the perimeter of the cylinder to press the plant material towards its central axis. Concurrently a drive roller 232, which is driven at a faster rate of rotation than the auger housing 222, provides a drive to the surface of the cylinder of plant material which accentuates the twist along its length and so increases the degree of compaction.

As more material enters the auger housing 222 and is processed, a tight cylinder of plant fragment material is ejected from the trailing end of the roller unit 228. When a desired length of the plant material has passed out of the roller unit, a hydraulically driven reciprocating cutter 234 such as a coulter cutter is operated to cut through the protruding cylinder. A cylindrical length 236 which has been cut away drops into semi-cylindrical elongate tray 238 which trails the auger assembly. The tray 238 can be driven about a longitudinal axis to tip the cut cylinder 236 of plant material into the temporary storage unit 216 which is pulled by, and in line with, the tractor 212. The temporary storage unit 216 holds cylinders 236 of prepared plant fragments until the arrival of a truck (not shown) to take the cylinders from the field and to transport them to the site of the next part of the process.

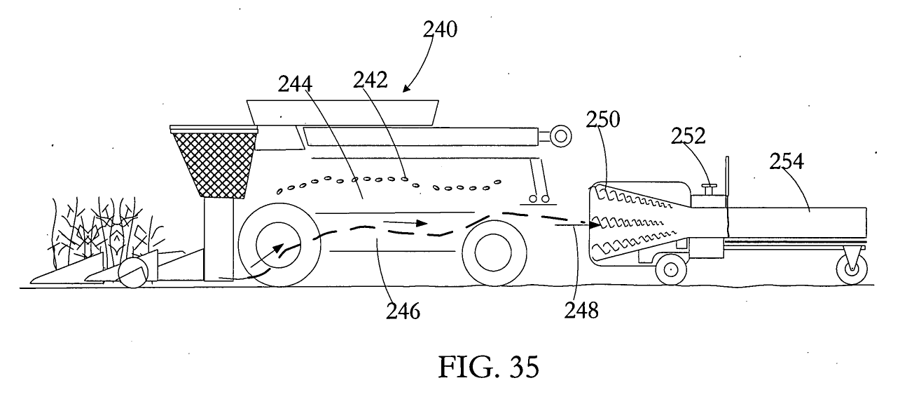

Referring in detail to FIG. 35, there is shown in side view with part cut away a variation of the equipment of FIG. 30. In this variation, a different prime mover is used, this being a combine harvester 240 instead of simply a pulling tractor. In this arrangement, the equipment is used to harvest and process standing crop plants such as corn or switch grass. In the example shown, corn is being harvested. Corn cobs 242, cracked off from the stem material, are directed through a top zone 244 of the harvester 240 and a remaining part of the corn plant cut away from a root portion is directed through a lower zone 246. Corn stover is directed from the back of the harvester together with husk material stripped from the corn cobs 242 within a processing unit of the harvester. The ejected stover and corn husk material 248 are then dealt with by a trailing conical auger assembly 250, roller unit 252 and cylindrical baler 254 in a manner similar to that described with respect to FIGS. 30-34.

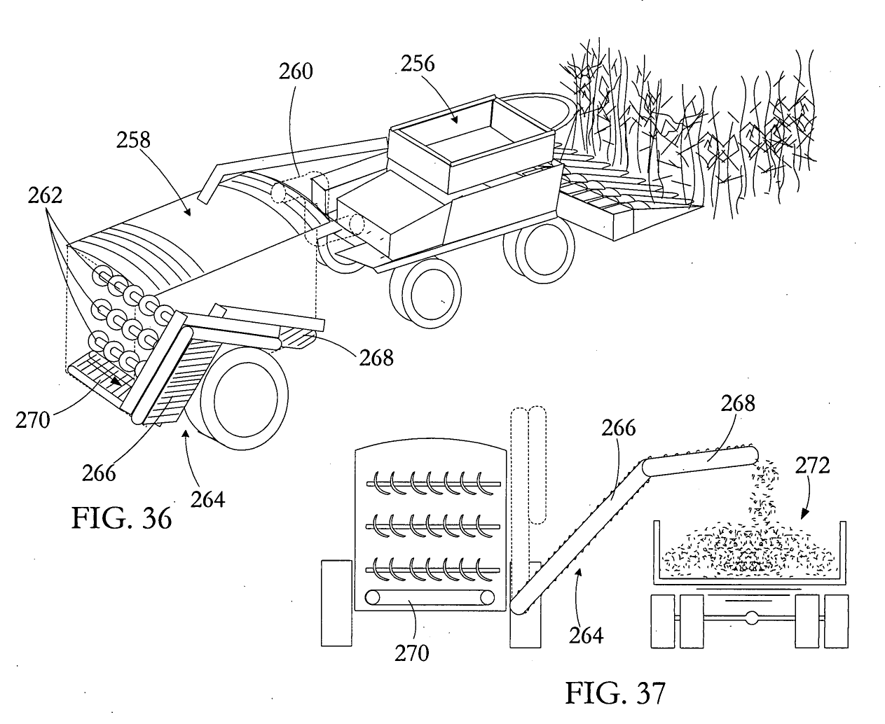

Referring in detail to FIGS. 36 and 37, alternative plant fragment collection equipment is shown which is adapted for collecting bio-fuel plant material from standing plants but which can fairly easily be modified to collect material from swath left after previously cutting a crop. The equipment includes a combine harvester unit 256 which tows a temporary collection cart 258. A blower and conduit arrangement 260 in front of the collection cart 258 and forming the last phase in the harvesting activity is operable to blow plant fragments of desired size into the cart 258. The plant fragments may be of the order of a quarter inch or may be larger up to one or two inches in length depending on the particular bio-fuel process to which the fragments are to be subjected in later phases of the bio-fuel preparation process. A series of augers 262 are mounted laterally inside the cart at its rear and at different heights. The augers 262 are operable to drive plant fragment material entrained in them to the right as shown in FIG. 37. Mounted at the side of the cart 258 adjacent a vertical opening in a sidewall of the cart, is a chain conveyor unit 264 which is movable between the position shown in phantom, in which it closes off the vertical opening, and the position shown in bold line. The conveyor unit 264 includes a lifting span 266 and an unloading span 268. A further conveyor 270 is mounted near the floor of the cart 258 and extends from side to side of the cart under the augers 262. In use, plant fragments are blown from the combine 56 into the cart 58 and the inside conveyor 270 and the augers 262 act to drive the plant material at all levels towards and out of the vertical opening in the cart wall. The plant material is then conveyed upwardly by the lifting span 266 and is directed to a position immediately above a collection truck 272 by the unloading span 268. The loading procedure is controlled by remote means (not shown) by the truck operator or the combine operator. As a variation on the conveyor unit 264, a further auger can be used to lift the plant fragments from the cart 258, the lifting auger having a delivery extension to deliver the plant fragments over and into a waiting truck.

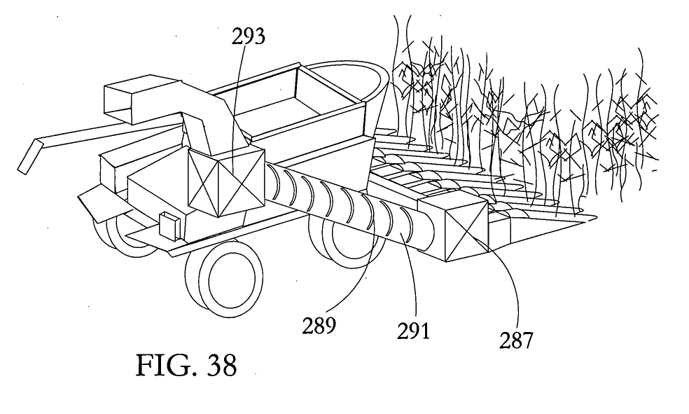

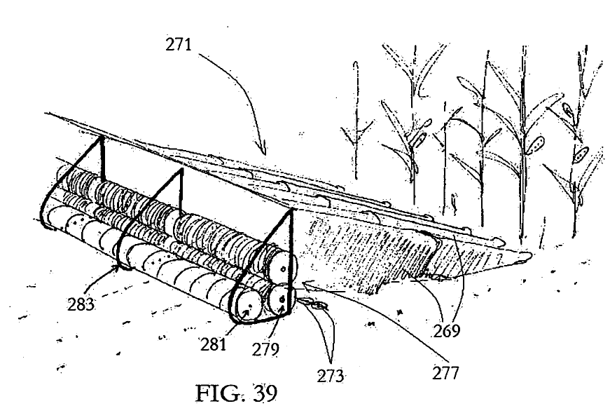

In an alternative embodiment of the invention illustrated in FIG. 38, a different loading system and procedure is used in which harvested material is guided to a side-mounted collection assembly generally shown as 265. As shown in the component view of FIG. 39, separators 269 at a harvesting head 271 separate the standing corn plants which are then cut by flail knives 273 mounted on rotatably driven, generally vertically disposed shafts. The cut plant remains drop towards the ground where they enter a throat section 277 between chopping rollers 279. The chopping rollers 279 cut the plant material to desired lengths.

In one embodiment, fragments of plant material exit the throat section of the chopping rollers and fall into a trailing auger 281. As shown in FIG. 39, the chopping rollers 279 and auger 281 are suspended from frame members 283 which are integrally mounted on the separators 269. On rotation of the auger 281, the plant material is guided to one side of the combine shown generally at 285 (the right hand side when looking in a forward direction as shown in FIG. 38). Mounted on this side of the combine 285 is a first blower 287 which is operable to blow the arriving plant fragments into a further auger 289 mounted in an inclined chamber 291 at the side of the combine 285 so as to drive the plant fragments upwardly and towards the rear of the combine. A second blower 293 is mounted at a trailing top end of the inclined chamber 291 and is operable to blow the plant fragment material into a trailing collection truck or cart (not shown).

This side-mounted unit can use a rising conveyor (not shown) as one alternative to the auger 289. In another alternative, the two blowers 287 and 293 are used to set up a current of air through the chamber 291 sufficient to pick up and transport the plant material fragments directly from the bottom blower 287 to the top blower 293.

Power for the various parts of the plant material processing equipment can be a power take off from a main vehicular drive unit or from a trailing collection cart. Alternatively, certain power take offs can be effected hydraulically. In addition the loading procedure can be controlled by remote means (not shown) by the cart operator or the combine operator.

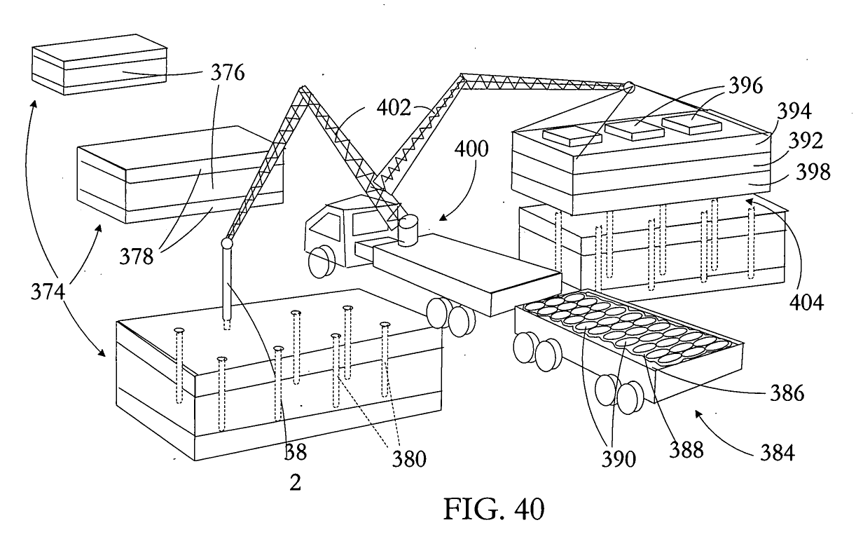

Referring to FIG. 40, there is shown a further arrangement adapted for a local environment such as a farm. Fragmented material brought into the farm site from the fields is built into stacks 374 of the order of 16 feet in length and 8 feet wide and deep. The stacks 374 are wrapped with a protective covering 376 of hemp, burlap or other easily biodegradable material. This acts both to keep the fragmented plant material together and to offer a first barrier against intrusion of the elements. The stacks 374 also have a second protective layer being top and bottom caps 378 of thick plastic sheet. The purpose of the plastic caps 378 is to keep moisture out as well as to add further strength to prevent damage to the stacks 374 as they are handled and transported. Once the hemp and plastic wrappings 376, 378 are in place, the plant fragment stacks 374 are drilled vertically on 4 feet centres as shown at locations using an air drill 382. It is preferred that the stacks 374 of fragmentary plant material are rendered as dry as possible. Removal of moisture means removal of volume and removal of a material which, at the levels that exist in the plant material has no real value in the bio-fuel preparation process. Reducing volume makes it easier to press the material into a block and to transport it.

The plant material stacks are then heated with the bores 380 through the stacks serving to distribute hot drying air to the interior of the stack. The drying assembly includes a heat exchange chamber 384 having a lattice of metal coils (not shown) through which heat transfer water is circulated. Reservoir water 386 in the chamber 84 surrounds the coils and is heated with fuel available at the drying farm site such as ethanol, methane, or solar heat. In the solar heated example shown, the heat exchange chamber 384 has a solar thermal blanket 388 in which are formed magnifier lens formations 390 lenses which act to focus sunlight on the reservoir water 386.

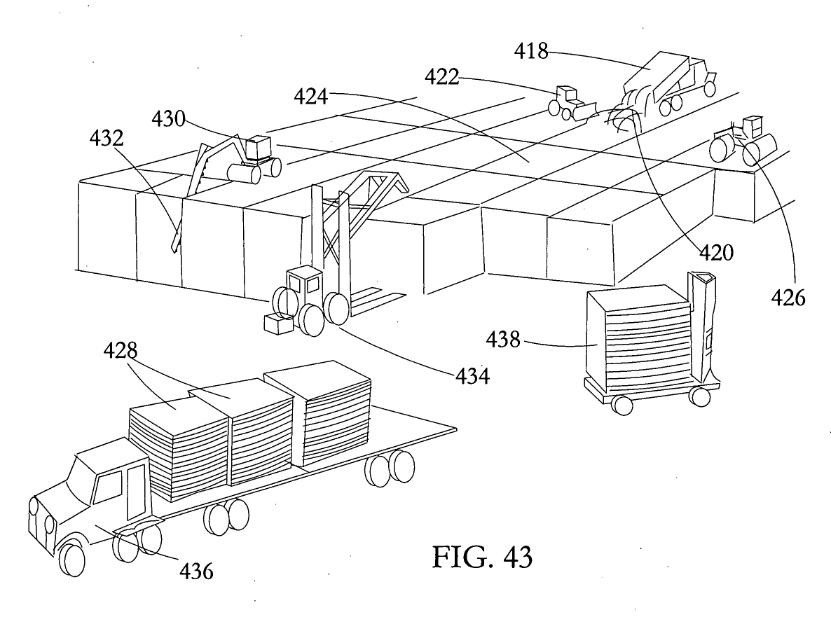

Hot water from the heat exchange chamber 384 is pumped through transfer pipes to a lattice of heat exchange coils (not shown) in a heating chamber 392. The heating chamber 392 is mounted under a fan chamber 394. Fans 396 are mounted above the heating chamber coils so as to direct air through them. The heating chamber 392 has a depending perimeter skirt 394 which, in use, fits over a plant material stack after a vehicle 400 from which the heating chamber 392 is suspended on a crane boom 402 is moved into position next to the stack. Between the top of the stack 374 and the heat exchange coils of the heating chamber 392 is an air plenum 404. After passing through the heat exchange coils in the heating chamber 392, the heat exchange water is pumped back through the transfer coils to the heat exchange chamber 384 to be reheated. Air pumped downwardly from the fans 396 into the air plenum 404 flows into the plant fragment stack to heat and dry the plant material. Hot air distribution is aided by the bores 380 extending through the stacks 374. While the stacks 374 in FIG. 43 are shown as being subjected only once to the drying treatment after which they are stored preparatory to being trucked away, the drying procedure can be applied periodically to retain the low moisture content. Alternatively, the blocks can be brought into a climate controlled environment and stored there.

The value of drying the plant fragment material is that it preserves the plant material against the growth of unwanted moulds. Moulds can be troublesome either because they affect a subsequent fermentation process or because they can affect the constitution of the end product. Ideally for storage, the moisture content is reduced to below 16% and preferably even lower to around 14%. However, if the stacks are to be transported to a cellulose processing facility within a short time such as 3 or 4 days, spoilage within that time is unlikely. In these circumstances, the process described with reference to FIG. 40 can be modified to initiate a further stage in the bio-fuel processing with this stage of the bio-fuel processing being completed after the stack material has been transported to a processing facility. In such a modification, a fermentation starter solution is pumped with the air into the block. The fermentation starter solution includes an acid preservative such as Silo Guard® which keeps unwanted molds and yeasts dormant but which also contains fermentation aids. Added to the preservative are water, further yeast to stimulate fermentation, and liquid nitrogen. The particular recipe depends on the particular plant material being processed and other ambient conditions. The fermentation initiation process can involve multiple applications of the fermenting starter material. In these applications, the particular components of the fermentation recipe applied to the block material can be changed to optimize the process, or the stacks 74 can be stored in a controlled environment particular receptive to promoting the desired fermentation.

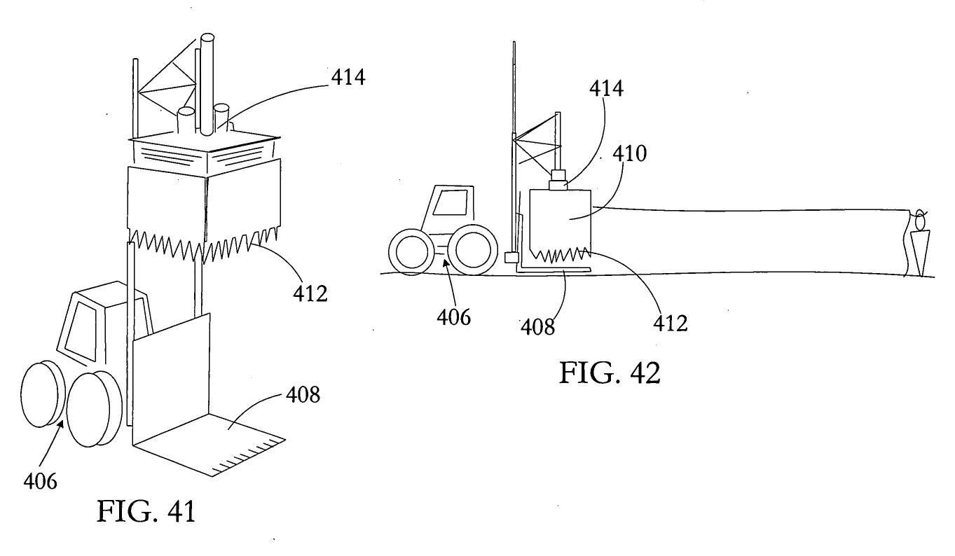

Clearly, plant material, unlike some more dense fuel materials such as coal or crude oil, is not particular homogenous but includes material parts of different density such as leaves and stems, moisture, and when first gathered a significant amount of air between plant material fragments themselves. It is desirable to reduce transport costs as much as possible and one way of doing that is to make the material less voluminous for the same amount of bio-fuel potential. In this respect, FIGS. 41 and 42 show a block preparation unit for use with a previously stored area of sized cellulose; i.e. plant material that has been cut to a fragment size desired for and adapted for a following bio-fuel processing process, but which has not been packed. Mounted to a tractor unit 406 is a loading base 408 4 feet by 4 feet in area. Mounted above the loading base 408 is a rectangular, vertically reciprocating cutting head 410 having walls ending in teeth 412. Mounted for reciprocation within the cutting head 410 is a packing cylinder 414. In use, the tractor 406 is driven forward to a position where the loading base 408 locates under the edge of a previously stored layer 416 of plant fragment material stacked to a depth of about six feet. The hydraulically driven cutting head 410 and the hydraulically driven compression packing cylinder 414 are then driven down to both pack a 4 feet by 4 feet area of the stacked plant material and to cut the 4 feet by 4 feet piece of the plant material away from the rest of the stacked plant stock material.

As an alternative to packing the plant fragment material and transporting it as a dried block, the plant fragment material can be treated locally to initiate the processes that will be completed at remote processing facility. In such a situation, the processing equipment of FIG. 40, which is typically located at a farm site, is used to add a water-acid-yeast solution to bring moisture in cellulose fibre up to 65-5% after which it is left to ferment. In order to have the fermentation proceed, it is necessary that the fragmented plant material is first packed with a system of the sort shown in FIGS. 41 and 42. The mix of plant fragments and the water-acid-yeast is then loaded as a slurry into a holding tank and left to ferment for a period of time.

After a period of fermentation, the fermented material is filtered to separate cellulose fiber waste from the ethanol containing juice. The waste material can also be squeezed by a packing cylinder of the sort illustrated in FIGS. 41 and 42 to further strain out valuable ethanol base liquid. The remaining solid can be distributed on the field to return nutrients to the ground while the leeched ethanol juices are pumped into a storage tank. Fully leeching out the ethanol bearing juices may take several applications of the fermentation mixture. In the farm facility, the storage area is located on a cement pad and with a storage tank below or just adjacent to the cement pad. Periodically, an ethanol truck is dispatched to the farm facility to pick up and filter the stored water-ethanol mix for taking to a production facility for further refining. As an alternative to this method of fermenting a slurry, the fragmented plant material can be subjected to a similarly liquid treatment but instead of leeching out essentially all of the ethanol containing “juice” from the slurry, only sufficient liquid is removed to obtain a desired weight reduction of the material block and to firm up, the plant fragments block. The block can then be transported to a larger scale processing plant.

As previously mentioned, one of the problems of cellulose plant material is that as collected, it is not dense. This means any transportation of the cellulose plant material to a processing plant involves carrying large volumes of material. Another arrangement for packing plant fragment material is shown in FIG. 43, this arrangement being applicable to a regional collection facility in comparison with the arrangement of FIGS. 41 and 42 which is more suited to a farm environment. FIG. 43 shows an operating facility to which cellulose fragmented material is being brought in trucks 418, the plant fragments then being emptied into a collection area 420. At one edge of the collection area 420, the plant fragments are bulldozed 422 towards a compaction area 424 at the centre of the collection area 420 to provide a first compaction of the material. A heavy roller 426 is driven over the plant material in the compaction area 424 to provide further gravity-assisted packing. The packing is valuable to exclude oxygen which if present with water in the right amount could lead to the generation of unwanted molds. The dual actions of bulldozing and rolling can pack the fragmented plant material to a density of the order of 24 pounds per cubic foot. This considerably reduces the availability of spoiling oxygen especially if the plant material has had its moisture content reduced either through drying in the field or through drying at the farm facility using a method of the sort described with respect to FIG. 40. Typically, a moisture content below 16% is desirable to reduce the chance of mold growth. The packed plant material stays in the compaction area until needed at which time blocks 428 of it are taken from a distribution edge of the compaction area 424. The blocks 428 are typically 8 feet by 8 feet by 8 feet cubes but can be bigger or smaller depending on the equipment to be used in the next phase of bio-fuel production. To prepare the blocks 428 a vehicular cutter unit 430 is driven onto the compaction area 424 and an articulated chainsaw 432 is positioned over the distribution edge. The hydraulically driven articulated chainsaw 432 is used to produce vertical cuts through the layer of cellulose material to define a readily detachable block 428. A fork lift truck 434 is then used to lift and detach the cut away block 428. The fork lift truck 434 takes the block 428 either to a packing zone 438 or to be loaded on a truck 436. At the packing zone 438, the block 428 is wrapped horizontally with burlap or similar bio-material which can be used integrally with the plant material in the next phase of bio-fuel processing.

In one embodiment, harvested plant fragment material (cellulose fibre) is treated locally at the farm to initiate processes that is completed at a remote processing facility.

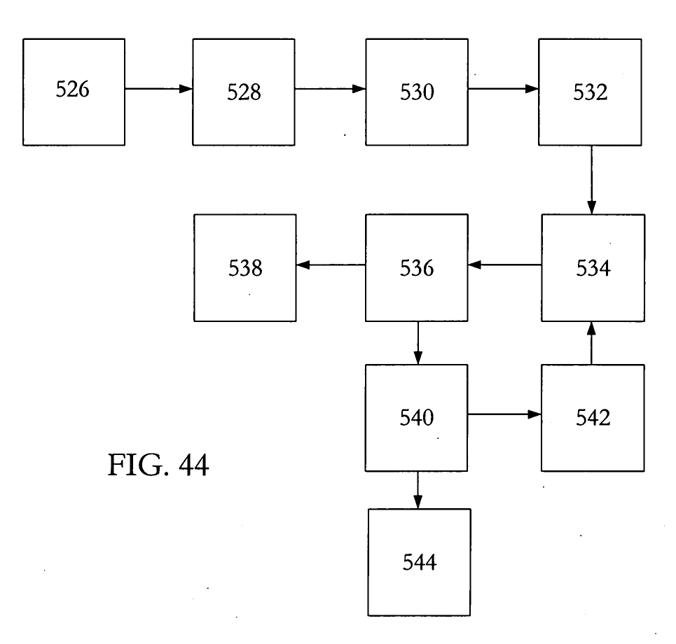

As described in more detail in the present application with reference to the process sequence diagram of FIG. 44, in such a farm-located process, the fragmented plant material is firstly tightly packed at a packing unit 526. Subsequently, a water-acid-yeast solution is added to the plant material at a mixing unit 528 to bring moisture in the harvested cellulose fibre up to about 65-75% and to initiate fermentation. Subsequently, the mix of plant fragments and the water-acid-yeast is loaded as slurry into a holding tank and left to ferment at a fermentation unit 30 for a period of time. The holding tanks are glass-lined (not shown) to combat leaching.

After a period of fermentation, the material is filtered at a filtration unit 532 to separate cellulose fiber waste from the ethanol-bearing juice. The material can also be squeezed at a pressure unit 534 to further strain out valuable ethanol base liquid. Following temporary storage and inspection at an inspection unit 536, the separated cellulose fiber waste is disposed of in the farm fields 538 to return nutrients to the ground while the leeched ethanol juices are pumped into a storage tank at a storage unit 540. Fully leeching out the ethanol-bearing juice may take several applications of the fermentation mixture as shown by recycling unit 542. The ethanol-bearing juice is stored in a safe storage tank at the farm. The storage area is located on a cement pad and with the storage tank below or just adjacent to the cement pad. Periodically, an ethanol transport tanker is dispatched to the farm to load the stored water-ethanol mixture for collection and transport 544 to a production facility for further refining.

In an alternative embodiment, where the farm facility is not equipped with filtering capability, the storage facility is adapted to store the slurry with the cellulose solid waste still present. In this embodiment, a filtering capability is mounted on the tanker and is operable to perform the filtering process as the ethanol-bearing material is pumped from slurry storage to the collection tanker.

One of the advantages of the split processing is that ethanol-bearing material is processed on the farm instead of being trucked to a dedicated ethanol processing plant. This represents a considerable saving in transportation costs and storage compared with doing all processing at a central facility. Local processing also has other advantages. By locally filtering off and disposing of the cellulose solid waste, there is no wasted back and forth journey for the solid component. Also there is a much reduced problem of solid waste disposal at the central facility, and, as a corollary, there is a direct return of valuable organic material to the earth at the farm. At the farm, the unused slurry waste is simply transported to a lagoon where it is tested and, if necessary further treated as necessary to meet disposal regulations, before being returned to the farm land to provide organic content. Moreover, there are reduced central storage needs and fire hazards.

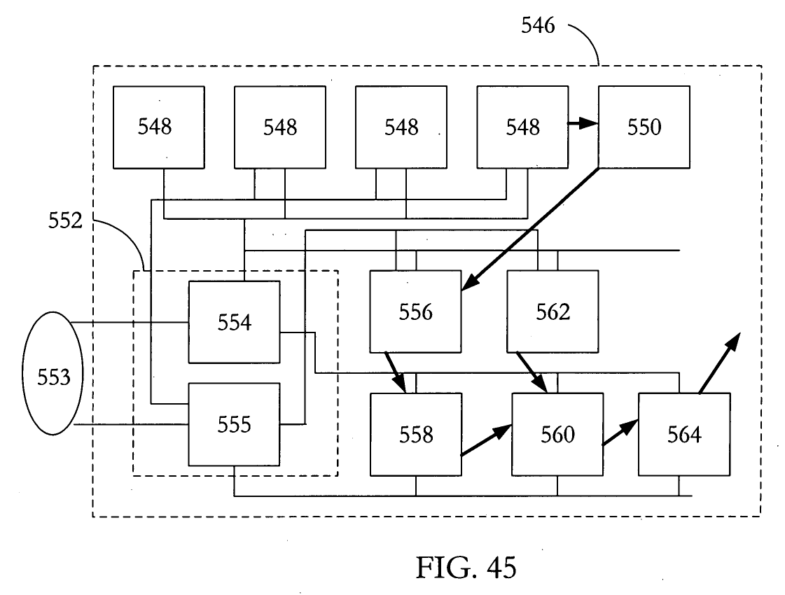

Although it makes practical sense to establish at least some of the ethanol processing in a farm environment, it is convenient to have later process steps carried out at a central facility which typically services several farms. As shown in the schematic process diagram of FIG. 45, a central facility 546 includes depot storage units 548 to receive and store ethanol-bearing juice arriving from the outlying farms. The central facility 546 also includes further processing units 550 to process the ethanol-water mix, and a central managing function 552 for both the central facility and, remotely, farm activity 553. The managing function includes a monitoring unit 554 to remotely monitor the activity at the farms for security, plant integrity, etc., as well as assess the stage of processing and the expected delivery time and volume of ethanol bearing juice to be delivered from the respective farms. The managing function also includes a control unit 555 which governs the operation of all other units at the central facility depending on inputs to the monitoring unit 554 from such other units. At the central facility 546, incoming deliveries of ethanol-bearing juice are batch analyzed at an analyzer unit 556 to assess how further processing should be optimized for the particular composition because the nature of ethanol bearing juice from the farms will vary from farm to farm depending, for example, on the composition of the starter crop. As part of the processing, the ethanol-bearing juice is subjected to both drying at a drying unit 558 to remove part of the water content and to further fermentation at a fermentation unit 560. Additives including fermenting yeasts are injected from a recipe selection unit 562 to optimize the mixture for further fermentation, processing and refining of the ethanol-bearing juice. Once fermentation is complete, more water is removed in a separator unit 564.

Capital and running costs are greatly reduced by having the split processing as described. For example, a new plant to do all ethanol processing starting with the harvested plant material costs of the order $330 million for a plant having a 200 million litres/year ethanol production capability. In contrast, local farms can be converted at a cost of from $100K to $200K each (or $5-10M for 50 farms) to perform the pre-processing for the same overall volume. Such an installation in normal circumstances is sited adjacent existing grain (or other crop) storage elevators. The central processing facility to service 50 farms typically has a capital cost of the order of $25M.

1. A processor for processing standing plants comprising a primary crop sub-system for processing upper parts of standing plants and a secondary crop sub-system for processing lower parts of standing plants, the primary and secondary crop sub-systems operable to process the respective upper and lower parts of the standing plants as the processor moves through a stand of the standing plants.

2. A processor for processing standing plants as claimed in claim 1, the primary crop sub-system having a first separator for separating the upper part of each of the standing plants from the lower part of each of the standing plants.

3. A processor for processing standing plants as claimed in claim 2, the primary crop sub-system further including a second separator for separating a primary crop portion of the upper part from a residue portion of the upper part.

4. A processor for processing standing plants as claimed in claim 3, further comprising a feed mechanism to collect the residue portion and to direct the residue portion to the secondary crop sub-system.

5. A processor for processing standing plants as claimed in claim 2, the first separator including a first mechanism to break corn ears from the standing plant.

6. A processor for processing standing plants as claimed in claim 5, the first separator further including a second mechanism to remove husk material from the corn ears.

7. A processor for processing standing plants as claimed in claim 2, the first separator comprising a first cutter for cutting the upper parts of the standing plants away from the lower parts of the standing plants, and a mechanism for processing the upper parts to separate grain content of the upper parts from chaff content of the upper parts.

8. A processor for processing standing plants as claimed in claim 7, the standing plants each having the upper part, the lower part and a root part, the secondary crop sub-system including a second cutter to cut the lower part of each standing plant away from the root part of the standing plant.

9. A processor for processing standing plants as claimed in claim 8, further including adjustment means to alter the positions of the first and second cutters to alter the lengths of the upper part, the lower part and the root part into which each of the standing plants is separated.

10. A processor for processing standing plants as claimed in claim 8, the secondary crop sub-system further including a feeder operable to receive the cut lower parts from the second cutter, to orientate the cut lower parts into general alignment, and to pass the cut lower parts to a chopping head.

11. A processor for processing standing plants as claimed in claim 10, the chopping head having a first member bearing chopping elements, and a second member bearing abutment elements, the first member rotatable relative to the second member and the chopping elements and the abutment elements disposed relative to each other to effect a chopping action on the cut lower parts passed to the chopping head.

12. A processor for processing standing plants as claimed in claim 11, the chopping elements being one of flail knives and toothed blades.

13. A processor for processing standing plants as claimed in claim 1, the primary crop sub-system and the secondary crop sub-system occupying first and second zones respectively of the processor, the first zone located above and forwardly of the second zone in a drive direction of the processor.

14. A processor for processing standing plants as claimed in claim 11, the chopping elements and abutment elements dimensioned and located to chop the plant material into fragments in the range of one quarter inch to one inch, the secondary crop sub-system further including a director means to direct the fragments to a collector.

15. A processor for processing standing plants as claimed in claim 11, the chopping elements and the abutment elements dimensioned and located to chop the plant material into lengths of the order of several inches to one foot, the secondary crop sub-system further including a director means operable as the processor moves through a stand of the standing plants, to eject the lengths from the harvester as a swath.

16. A method of processing standing plants comprising moving a processor having a primary crop sub-system and a secondary crop sub-system through a stand of standing plants, operating the primary crop sub-system to separate an upper part of each of the standing plants from a lower part of the standing plant and to process the upper part, and operating the secondary crop sub-system to cut a lower part of the standing plant from a root part of the standing plant and to process the lower part.

17. A method of processing standing plants as claimed in claim 18, further comprising operating the primary crop sub-system to separate an upper part of each of the standing plants from a lower part of the standing plant by breaking a corn ear from the standing plant.

18. A method of processing standing plants as claimed in claim 19, further comprising operating the primary crop sub-system to process the upper part by removing husk material from the corn ear and directing the removed husk material to the secondary crop sub-system.

19. A method of processing standing plants as claimed in claim 18, further comprising altering a height setting of at least one of the primary crop sub-system and the secondary crop sub-system to alter the length of at least one of the upper part of each standing plant and the lower part of the standing plant.

20. A method of processing standing plants as claimed in claim 18, further comprising receiving the cut lower parts, orientating the cut lower parts into general alignment, and passing the cut lower parts to a chopping head.

21. A method of processing standing plants as claimed in claim 23, further comprising chopping the cut lower parts with a rotary chopping head into fragments generally in the range of one quarter of an inch to one inch, and directing the fragments to a collector.

22. A method of processing standing plants as claimed in claim 23, further comprising chopping the cut lower parts into lengths generally in the range of several inches to one foot and directing the chopped lengths to a field-based swath.

23. A processor for processing standing plants comprising a primary crop sub-system for processing primary crop parts of standing plants and a secondary crop sub-system for processing secondary crop parts of standing plants, the primary and secondary crop sub-systems operable to process the respective primary and secondary crop parts of the standing plants as the processor moves through a stand of the standing plants.

24. A processor as claimed in claim 27, the primary crop sub-system including a mechanism for stripping corn cobs from the standing plants.

25. A processor as claimed in claim 28, the secondary crop sub-system including a mechanism for cutting standing plants stripped of corn cobs into at least one of fragments and lengths.
